(19) United States
(12) Patent Application Publication
(10) Pub. No.: US 2005/0180309 A1
(43) Pub. Date: Aug. 18, 2005

(54) Information recording medium, a method for recording information and a method for manufacturing a medium

(75) Inventors: Makoto Miyamoto, Ome (JP); Junko Ushiyama, Kokubunji (JP); Yasushi Miyauchi, Akishima (JP); Kazuyo Umezawa, Moriya (JP); Akira Kashiwakura, Moriya (JP); Reiji Tamura, Moriya (JP)

Correspondence Address: REED SMITH LLP;Suite 1400, 3110 Fairview Park Drive, Falls Church, VA, 22042-4503, US

(73) Assignees: Hitachi, Ltd.; Hitachi Maxell, Ltd.

(21) Appl. No.: 11/103,625

(22) Filed: Apr. 12, 2005

Related U.S. Application Data
(63) Continuation of application No. 10/228,208, filed on Aug. 27, 2002.

(30) Foreign Application Priority Data
Mar. 27, 2002 (JP) 2002-087386

(51) Int. Cl. G11B 7/24; G11B 7/26

(52) U.S. Cl. 369/288; 369/283; 369/94

(57) ABSTRACT

An information recording medium includes a structure fabricated by successively depositing a first protective layer, a first interface layer, a recording layer, a second interface layer, a second protective layer, an absorptivity control layer and a thermal diffusion layer on a substrate which is placed on a laser-beam-incident side of the medium, in which the first interface layer and the second interface layer are formed so as to contain elements Bi, Sn, Pb, etc. having the effect of promoting the crystallization of the recording layer and the total content of the elements in the first interface layer is set lower than that in the second interface layer, thereby reducing playback signal deterioration after frequent rewriting.

### BACKGROUND OF THE INVENTION

1. Field of the Invention

The present invention relates to an information recording medium on which information is recorded by means of energy beam irradiation, a method for recording information, and a method for manufacturing a medium, and in particular, to a phase-change medium such as DVD-RAM and DVD-RW, an information recording method using the phase-change medium, and a method for manufacturing the phase-change medium.

2. Description of the Related Art

In recent years, the market for read-only optical disks such as DVD-ROM and DVD-Video are growing. Rewritable DVDs such as 4.7 GB DVD-RAM and 4.7 GB DVD-RW have also been introduced on the market, and the market for the rewritable DVDs, as backup media for computers and video recording media for replacing VTRs, is also expanding rapidly. Meanwhile, there are increasing market requirements through the years with regard to the improvement of the transfer rate and access speed of the writable DVDs.

In the writable and erasable DVD media such as DVD-RAM and DVD-RW, the so-called “phase change recording method” is employed. In the phase change recording method, information recording is carried out by associating data “0” and “1” with crystalline and amorphous, respectively. Since the crystalline part and the amorphous part of the disk or medium have different refractive indices, the thickness and refractive index of each layer of the disk are usually designed deliberately so that the difference of reflectivity between the crystalline part and the amorphous part will be maximum. By irradiating the crystalline parts and the amorphous parts of the disk with a laser beam and detecting reflected light, the data “0” and “1” which have been recorded on the disk can be detected and reproduced.

In order to turn a part of the disk into amorphous (such operation is called “recording”), the part is irradiated with a laser beam of relatively high power and thereby the temperature of the recording layer is raised to a temperature above the melting point of the recording layer material. On the other hand, in order to turn a part of the disk into crystalline (such operation is called “erasing”), the part is irradiated with a laser beam of relatively low power and thereby the temperature of the recording layer is raised to a temperature near the crystallization temperature of the recording layer material which is lower than the melting point of the recording layer material. By such operations, the phase change between amorphous and crystalline is realized in a reversible manner.

For letting the writable DVD meet the aforementioned requirement of improving the transfer rate, the revolving speed of the medium is generally increased so that the recording/erasing time will be reduced. A problem in this case is the recording/erasing characteristics of the medium when the medium is overwritten with information. In the following, the problem will be discussed in detail.

Here, a case where a designated part of the medium is turned from amorphous into crystalline will be considered. When the revolving speed of the medium is raised as mentioned above, the residence time of the laser beam on the designated part becomes short and thereby the time during which the designated part is held at the crystallization temperature also becomes short. If the time for holding the designated part at the crystallization temperature becomes too short, an amorphous part tends to remain at the designated part of the medium due to insufficient crystal growth. Such amorphous part gives ill effects on the playback signal and thereby the playback signal quality is deteriorated.

In order to resolve the problem, two methods: (1) Speeding up the crystallization of the recording layer by changing the composition of the recording layer; and (2) Using specific materials capable of promoting the crystallization of the recording layer in an interface layer which is in contact with the recording layer, can be employed.

For example, in JP-A-2001-322357, Ge—Sn—Sb—Te-based material doped with metal Ag, Al, Cr, Mn, etc. is employed as the recording material, and according to the document, an information recording medium having high-density recording capability, high repetitive rewritability, and slow deterioration of crystallization sensitivity with time can be obtained. JP-A-2-14289 also includes a description on the Ge—Sn—Sb—Te-based recording layer material.

In JP-A-5-342629, an interface layer made of Sb₄₀Te₁₀Se₅₀ etc. for promoting the crystallization of the recording layer is provided so as to be in contact with the recording layer so that the recording layer can be crystallized in a short time. JP-A-9-161316 employs a layer made of Sb₂Te₃ etc. as the interface layer (crystallization promotion layer) in order to realize an initial crystallization process with extremely high speed. Further, JP-A-2001-273673 employs a layer made of SnTe, PbTe, etc. as the interface layer (crystal nucleus generation layer) in order to obtain an information recording medium whose crystallization speed does not drop even after long-term storage.

When information is recorded on an optical disk employing the phase change recording method, the revolving speed of the optical disk is generally controlled by means of CLV (Constant Linear Velocity), that is, maintaining the relative velocity of the optical disk with respect to the laser beam at a constant speed. On the other hand, in CAV (Constant Angular Velocity), the angular velocity of the rotated optical disk is kept constant.

The features of CLV include: (1) Extremely simple signal processing circuit due to the constant read/write data transfer rate; (2) Lighter load on the medium due to uniform temperature hysteresis of the recording layer on recording/erasing, thanks to the constant relative velocity between the optical disk and the laser beam; and (3) The need of changing and controlling the motor revolving speed depending on the radial position of the laser beam on the optical disk when the laser beam is moved in the radial direction of the optical disk. Due to the third feature of the CLV, the access speed is deteriorated significantly.

On the other hand, the features of CAV include: (1) Large circuit scale required of the signal processing circuit due to the read/write data transfer rate changing depending on the radial position of the laser beam on the optical disk; (2) The need of a specially composed optical disk due to temperature hysteresis of the recording layer on recording/erasing changing depending on the radial position owing to the beam-disk relative velocity changing depending on the radial position; and (3) Possibility of high-speed access thanks to the absence of the need of changing and controlling the motor revolving speed depending on the radial position when the laser beam is moved in the radial direction of the optical disk.

By employing the recording layer material and the interface layer material disclosed in the conventional techniques, excellent reading/writing characteristics can be realized even when the disk linear velocity is high. However, since problems in CAV recording have not been considered in the conventional techniques, the quality of playback signals deteriorated significantly in the CAV recording when data recorded at the inner radius of the information recording medium were read out.

Further, the conventional interface layers made of Sb₄₀Te₁₀Se₅₀, Sb₂Te₃, SnTe, PbTe, etc. had problems of dissolving into the recording layer due to frequent rewriting of about 100,000 times and thereby deteriorating the playback signal quality.

### SUMMARY OF THE INVENTION

It is therefore the primary object of the present invention to provide an information recording medium by which the CAV recording can be realized and the playback signal deterioration can be eliminated even after frequent rewriting of about 100,000 times.

Another object of the present invention is to provide a method for manufacturing an information recording medium by which the CAV recording can be realized and the playback signal deterioration can be eliminated even after frequent rewriting of about 100,000 times.

In order to obtain such an information recording medium capable of realizing the CAV recording and eliminating the playback signal deterioration even after frequent rewriting of about 100,000 times, we summarize here the problems of the conventional information recording media.

The problems to be resolved by the present invention are:
1) Dissolution of the interface layer material into the recording layer due to frequent rewriting; and
2) Deterioration of playback signal quality in CAV recording at the inner radius of the information recording medium.

In the following, the causes of the problems 1) and 2) will be discussed one by one, taking an information recording medium having the layer structure of FIG. 1 as an example. In the medium of FIG. 1, a first protective layer, a first interface layer, a recording layer, a second interface layer, a second protective layer, an absorptivity control layer, a thermal diffusion layer and an ultraviolet-curing protective layer are successively deposited and stacked up on a substrate. Incidentally, information recording media in which the effects of the present invention can be obtained are of course not limited to the structure of FIG. 1.

1) Cause of Dissolution of Interface Layer Material into Recording Layer

The phenomenon will be explained referring to FIG. 2. FIG. 2 is a cross-sectional view showing part of an information recording medium around the recording layer. In the information recording medium of FIG. 2, the interface layer materials Sb₄₀Te₁₀Se₅₀, Sb₂Te₃, SnTe, PbTe, etc. employed in the conventional interface layers are employed for the first interface layer and the second interface layer. The laser beam converged by a lens focuses on the recording layer as shown in FIG. 2. In this case, the laser beam is mainly absorbed into a surface of the recording layer on the side of the first interface layer, and consequently, the recording layer is heated up mainly on its surface facing the first interface layer. As above, when the information recording medium has the structure of FIG. 1, the temperature on the surface of the recording layer facing the first interface layer tends to be higher than that on the other surface facing the second interface layer.

The interface layer material for promoting the crystallization of the recording layer generally has a melting point lower than that of generally used interface layer materials Ge₃N₄, Cr₂O₃, etc., therefore, selective dissolution of the interface layer material from the first interface layer into the recording layer is caused by the frequent rewriting of about 100,000 times. The present inventors have found out that Bi₂Te₃ also exhibits excellent function for promoting the crystallization of the recording layer; however, Bi₂Te₃, also having a low melting point of about 600° C., had problems similar to those of the conventional interface layer materials. Meanwhile, the present inventors also made it clear that the crystallization promotion effect for the recording layer can also be obtained by only adding specific elements Sn, Pb, Bi, etc. in the interface layer material, without the need of employing the compounds of the conventional techniques Sb₄₀Te₁₀Se₅₀, Sb₂Te₃, SnTe, PbTe, etc. for the interface layer. Such elements Sn, Pb, Bi, etc. combine with Te which is included in the recording layer and thereby forms crystalline compounds SnTe, PbTe, Bi₂Te₃, etc. Such crystalline compounds generated on the surface of the interface layer function as crystal nuclei and thereby promotes the crystallization of the recording layer. For example, the recording layer crystallization promotion effect can also be obtained even if oxides SnO₂, PbO₂, Bi₂O₃, etc., sulfides SnS₂, PbS, Bi₂S₃, etc. or selenides SnSe₂, PbSe, Bi₂Se₃, etc. of the above elements are employed as the interface layer materials, since the elements liberated from the compounds combine with Te in the recording layer and thereby forms the crystalline compounds. However, the oxides, sulfides and selenides also have thermal instability, by which the playback signal quality is deteriorated due to the dissolution of the elements into the recording layer.

On the other hand, such problems do not occur when compounds such as Cr₂O₃, Ge₃N₄, etc. having high melting points and thermal stability but lacking the recording layer crystallization promotion effect are employed only for the first interface layer and the conventional interface layer materials Sb₄₀Te₁₀Se₅₀, Sb₂Te₃, SnTe, PbTe, etc. are employed for the second interface layer. The fact indicates that the dissolution of the interface layer material into the recording layer occurs selectively from the side of the first interface layer. As above, the cause of the interface layer material dissolution into the recording layer is the material dissolution from the first interface layer, which is caused by the heating up of the recording layer surface facing the first interface layer. Incidentally, if the interface layer materials lacking the recording layer crystallization promotion effect are employed for the first interface layer as mentioned above, sufficient crystallization of the recording layer can not be attained in high-speed recording.

2) Cause of Playback Signal Deterioration in CAV Recording at Inner Radius of Information Recording Medium

First, crystallinity around amorphous marks at the outer radius of the information recording medium where playback signal deterioration does not occur, will be explained referring to FIGS. 4A and 4B. FIG. 4A is a schematic diagram showing amorphous marks which are recorded on a crystalline area of the information recording medium and the crystallinity around the amorphous marks. FIG. 4A shows a distinctive feature that melted areas melted by laser beam irradiation directly turn into the amorphous marks. As shown in FIG. 4B, even when the amorphous marks of FIG. 4A are overwritten with new amorphous marks, the old amorphous marks of FIG. 4A are crystallized perfectly.

Next, the cause of the playback signal deterioration at the inner radius of the information recording medium will be explained referring to FIGS. 3A and 3B. FIG. 3A is a schematic diagram showing the crystallinity around amorphous marks when the amorphous marks are recorded at the inner radius of the conventional information recording medium. FIG. 3A shows a distinctive feature that the amorphous marks are considerably smaller than the melted areas. This is caused by “shrinking” of the amorphous marks. When an amorphous mark is recorded, crystal growth occurs from the outer edge of the melted area melted by the laser beam, by which the shrinking of the amorphous mark (recrystallization) occurs. The problem is caused as follows. In the CAV recording, the disk linear velocity is slower at the inner radius of the information recording medium than at the outer radius. Therefore, the cooling rate of the melted area becomes lower at the inner radius due to the heat of the slowly-passing laser beam, thereby the recrystallization of the amorphous area occurs at the inner radius.

By the above mechanism, the final size of the amorphous mark becomes smaller than that of the melted area and thereby the amplitude of the playback signal becomes smaller (problem 1). Further, the crystal grain size in the recrystallization area which caused the shrinking is larger than that in a normal crystallization area. As shown in FIG. 3B, when the amorphous marks of FIG. 3A are overwritten with new information or new amorphous marks, crystals of different grain sizes tend to remain between the new amorphous marks. The crystals of different grain sizes have different reflectivity, therefore, dispersion of reflectivity is caused by the dispersion of crystal grain size, thereby noise in the playback signal increases (problem 2). Further, the dispersion of crystal grain size also causes dispersion of thermal conductivity, melting point and crystal growth speed. Consequently, the shape of the amorphous mark is affected by the crystal grain size dispersion and thereby the playback signal quality is deteriorated (problem 3). As discussed above, leading causes of the playback signal deterioration at the inner radius of the information recording medium are the problems 1 through 3 which are caused by the recrystallization.

Next, concrete measures for resolving the above problems 1) and 2) will be discussed.

1) Suppression of Dissolution of Interface Layer Material into Recording Layer after Frequent Rewriting

The problem 1) can be resolved by letting the first and second interface layers contain the aforementioned elements Bi, Sn, Pb, etc. having the recording layer crystallization promotion effect, and setting the total content of the elements Bi, Sn, Pb, etc. in the first interface layer lower than that in the second interface layer for preventing the elements having low melting points from dissolving into the recording layer.

Since the melting point of Te is also low, also when the compounds of Te SnTe, PbTe, Bi₂Te₃, etc. are employed for the first interface layer or the second interface layer, it is effective to set the total content of the elements Bi, Sn, Pb, Te, etc. in the first interface layer lower than that in the second interface layer.

The reduction of the content of the elements Bi, Sn, Pb, Te, etc. in the interface layer can be attained efficiently by doping the interface layer with Ge—N-based material having thermal and chemical stability, since Ge is in the same group with Sn and Pb in the periodic table and can also form compounds with Bi and Te easily. Incidentally, the elements Bi, Sn, Pb and Te hardly combine with nitrogen, therefore, deterioration of the recording layer crystallization promotion effect due to the addition of the Ge—N-based material can be avoided.

As a method for forming the interface layer, the following method can advantageously be employed, since the cost of sputtering targets can be reduced, thermal damage to the substrate is light, DC sputtering which is capable of lowering the cost of the sputtering apparatus can be employed, and the Ge—N-based material can be added to the interface layer uniformly. The method is: forming the interface layer by carrying out sputtering using a sputtering gas containing nitrogen and a sputtering target containing Te, Ge and at least one element selected from Bi, Sn and Pb.

Other than the addition of the Ge—N-based material, it is also effective to add transition metal oxides or transition metal nitrides since transition metal easily changes its valence. Even when the elements Bi, Sn, Pb, etc. are liberated, the transition metal changes its valence and combines with Bi, Sn and Pb and thereby forms thermally stable compounds. Especially, Cr, Mo and W can be employed as excellent transition metals since they have high melting points and easily change their valences and form thermally stable compounds with the elements.

There are cases where the thickness of the first interface layer has to be set to 3 nm or less in order to meet optical requirements or for controlling the crystallization of the recording layer. In such cases, the first interface layer might be formed not as a flat layer but as spots. Even so, the recording layer crystallization promotion effect is not lost; however, sulfur contained in ZnS—SiO₂ which is used for the first protective layer might dissolve into the recording layer through the first interface layer. The sulfur dissolution problem can be resolved by using material containing SnO₂ which is thermally more stable than ZnS—SiO₂ and contains Sn capable of promoting the crystallization of the recording layer in place of ZnS—SiO_{2.}

The thermal load or heat load on the second interface layer in the information recording is lighter than that on the first interface layer; however, there are cases where the thickness of the second interface layer has to be set to 1 nm or less in order to meet optical requirements or for controlling the crystallization of the recording layer and thereby the second interface layer might be formed not as a flat layer but as spots. Even so, the recording layer crystallization promotion effect is not lost; however, sulfur contained in ZnS—SiO₂ (which is used for the second protective layer) might dissolve into the recording layer through the second interface layer. The sulfur dissolution problem can also be resolved by using material containing SnO₂ which is thermally more stable than ZnS—SiO₂ and contains Sn capable of promoting the crystallization of the recording layer in place of ZnS—SiO₂.

2) Suppression of Playback Signal Deterioration in CAV Recording at Inner Radius of Information Recording Medium

Next, concrete measures for suppressing the playback signal deterioration in CAV recording at the inner radius of the information recording medium will be discussed. As mentioned before, the cause of the playback signal deterioration in CAV recording at the inner radius is the shrinking of the amorphous marks (recrystallization) occurring in the amorphous mark recording due to the crystal growth starting from the outer edges of the melted areas. Therefore, the problem 2) can be resolved by suppressing the recrystallization. The suppression of recrystallization can be attained by employing material that is less prone to crystallize, that is, material whose crystal growth speed is slow as the recording layer material. However, if such material is employed for the recording layer, at the outer radius of the information recording medium where the disk linear velocity becomes higher, the heating time by the laser beam and the time for holding the recording layer at the crystallization temperature become short and insufficient, thereby amorphous marks to be crystallized can not be crystallized enough.

Therefore, the present inventors carried out extensive researches for resolving the problem and could found out an essential solution to the problem. In the following, the solution will be explained in detail referring to FIGS. 5 through 8.

FIG. 5 is a graph for explaining the mechanism of the recrystallization occurring to a conventional information recording medium. The crystallization of the recording layer can generally be attributed to two types of phenomena, that is, nucleation and crystal growth. The speeds of the nucleation and crystal growth are functions of temperature as shown in FIG. 5. Referring to FIG. 5, the crystal growth speed reaches its maximum at a temperature just below the melting point of the recording layer material, and the nucleation speed reaches its maximum at a temperature lower than the maximum crystal growth temperature, that is, temperature at which the crystal growth speed reaches its maximum.

Incidentally, in the phase change recording, the amorphous mark is crystallized by heating the recording layer material to a temperature near its crystal growth temperature which is lower than its melting point, as mentioned before. During the heating of the recording layer material, the temperature rises through the maximum nucleation temperature, that is, temperature at which the nucleation speed reaches its maximum, thereby crystal nuclei are formed in the recording layer. As the temperature rises further, the crystal growth speed becomes faster and crystals grow around the crystal nuclei which were formed at a lower temperature, thereby the whole amorphous mark can be crystallized.

On the other hand, when the amorphous mark is recorded, the temperature of the recording layer is raised to a temperature above the melting point of the recording layer material. As the recording layer material is cooled, the recording layer turns into amorphous at the center of the amorphous mark. However, at the outer edge of the melted area, when the outer edge is cooled to about the maximum crystal growth temperature just below the melting point, crystal growth starts from the outer edge toward the center of the melted area, thereby the final size of the amorphous mark becomes smaller than that of the melted area (see FIG. 6). The re-crystallization is caused by the above mechanism.

The recrystallization problem can be resolved by lowering the maximum value of the crystal growth speed and raising the maximum value of the nucleation speed as shown in FIG. 7. By the method, the crystal growth from the outer edge of the melted area on the amorphous mark recording can be suppressed (see FIG. 8). Meanwhile, when the amorphous mark is crystallized, the number of crystal nuclei generated at the maximum nucleation temperature becomes larger than in the case of FIG. 5, therefore, the whole amorphous mark can be crystallized even if the crystal growth speed decreased.

In order to raise the maximum nucleation speed and lower the maximum crystal growth speed as shown in FIG. 7, the present inventors found out the following two methods.

Method A: Use material having low nucleation speed and low crystal growth speed as the recording layer material and use material capable of increasing the nucleation speed for the interface layer; and

Method B: Use material having high nucleation speed and low crystal growth speed as the recording layer material.

The methods A and B will hereafter be explained in detail.

The method A can be realized by adding the aforementioned elements Sn, Pb, Bi, etc. in the interface layer. In this case, chalcogenide complexes of the elements Sn, Pb, Bi, etc. such as oxides SnO₂, PbO₂, Bi₂O₃, etc., sulfides SnS₂, PbS, Bi₂S₃, etc., selenide compounds SnSe₂, PbSe, Bi₂Se₃, etc. and telluride compounds SnTe, PbTe, Bi₂Te₃, etc. of the elements can be employed as the interface layer materials. What is essential in the interface layer material is that Te in the recording layer combines with Sn, Pb and/or Bi and thereby complexes SnTe, PbTe, Bi₂Te₃, etc., having extremely low crystallization temperature (lower than room temperature) and promoting the nucleation in the recording layer on the recording layer crystallization, are generated on the surface of the interface layer. Of course, the nucleation effect in the recording layer becomes maximum in the case where the tellurides of Sn, Pb and/or Bi are included in the interface layer; however, the oxides, sulfides and selenides of Sn, Pb and Bi have higher melting points than the tellurides and thus are more effective in preventing Sn, Pb and Bi from dissolving into the recording layer. Further, the oxides, sulfides and selenides of Sn, Pb and Bi, having lower absorptivity than the tellurides of Sn, Pb and Bi, are more advantageous in that flexibility in optical design can be increased. Ideally, it is desirable if a mixture of the tellurides of Sn, Pb and/or Bi and high-melting-point compounds Ge₃N₄, Cr₂O₃, etc. can be used as the interface layer material as mentioned before, since the dissolution of the elements into the recording layer due to frequent rewriting can be suppressed and the optical design flexibility can also be increased by the reduction of the absorptivity of the interface layer.

As the recording layer material, a material comprised of the well-known Ge—Sb—Te-based recording layer material containing GeTe and Sb₂Te₃ in a proper mixture ratio and an excessive amount of Sb added thereto can be employed. Specifically, recording layer materials within the following compositional formula (atomic percent) are excellent.
Ge_{X-Y}Sb_{40-0.8X+2Y}Te_{60-0.2X-Y}
(20<X<45, 0.5<Y<5)

Other than the excessive doping with Sb, it is also possible to add elements capable of reducing the nucleation speed and the crystal growth speed. Specifically, recording layer materials within the following compositional formula are excellent.
(Ge_{X-Y}Sb_{40-0.8X+2Y}Te_{60-0.2X-Y})_{100-Z}M_{Z}
(20<X<45, 0.5<Y<5, 0.5<Z<5)

M is an element selected from elements Ag, Cr, Si, Ga, Al, In, B and N.

The crystal growth speed of the recording layer should be as slow as possible; however, the problem of insufficient amorphous mark crystallization at the outer radius of the information recording medium occurs if the crystal growth speed is too slow. The problem can be avoided by adding material having the recording layer crystallization promotion effect to both the first and second interface layers as much as possible. However, the dissolution problem of the elements Sn, Pb, Bi, etc. into the recording layer after frequent rewriting occurs if the elements are added to the first interface layer in high volume. Therefore, the content of the elements contained in the first interface layer should be set lower than that in the second interface layer.

Next, the methods B will be explained in detail.

The present inventors found out that the nucleation speed can be improved and thereby excellent reading/writing characteristics can be obtained also in the CAV recording from the inner radius to the outer radius of the information recording medium by adding Bi₂Te₃ to the well-known Ge—Sb—Te-based recording layer material containing GeTe and Sb₂Te₃ in a proper mixture ratio. The Ge—Sn—Sb—Te-based material employed in one of the aforementioned conventional techniques also has an excellent nucleation speed; however, according to experiments conducted by the present inventors, the addition of Bi₂Te₃ is more effective for the improvement of the playback signal amplitude since the crystal growth speed becomes still higher and the difference of refractive index between amorphous and crystal also becomes still larger. Specifically, the effects can be obtained by setting the content of Bi to 1 to 9%. Especially, recording layer materials within the following compositional formula are excellent.
(Ge_{X-Y}Sb_{40-0.8X+2Y}Te_{60-0.2X-Y})_{100-Z}(Bi₂Te₃)_{Z}
(20<X<45, −2<Y<2, 5<Z<25)

Incidentally, even if other impurities are contained in the recording layer, the effects of the present invention are not lost if the relationship among the four elements is kept within the above compositional formula and the content of the impurities is 1 atomic % or less.

In the present invention, the information recording medium is sometimes referred to as “phase-change optical disk” or simply as “optical disk”; however, the present invention is applicable to any information recording medium on which information is recorded by heating the medium by means of irradiation with a energy beam and thereby causing changes in atomic arrangement. Therefore, the present invention can also be applied to information recording media such as optical cards that are not disk-like information recording media, regardless of the shape of the information recording medium.

While the aforementioned energy beam is sometimes referred to as “laser beam”, “laser light” or simply as “light” in this description, the effects of the present invention can be obtained by use of any energy beam that can heat the information recording medium as above. Therefore, the effects of the present invention can also be obtained if other types of energy beams such as an electron beam are used. While the present invention has been made for information recording media for red laser beams (wavelength: 645 to 660 nm), the wavelength is not particularly limited. Therefore, the present invention is also capable of achieving the effects for information recording media for lasers of relatively short wavelengths blue laser, ultraviolet laser, etc.

Further, while this description is given on the assumption that the substrate is placed on the light-incident side of the recording layer, the effects of the present invention can also be obtained when a protective material such as a thin protective sheet is placed on the light-incident side of the recording layer and the substrate is placed on the other side of the recording layer.

### BRIEF DESCRIPTION OF THE DRAWINGS

The objects and features of the present invention will become more apparent from the consideration of the following detailed description taken in conjunction with the accompanying drawings, in which:

FIG. 1 is a schematic diagram for explaining the composition of an information recording medium in accordance with the present invention;

FIG. 2 is a schematic diagram for explaining the principle of the present invention;

FIGS. 3A and 3B are schematic diagrams for explaining problems of conventional information recording media;

FIGS. 4A and 4B are schematic diagrams for explaining problems of conventional information recording media;

FIG. 5 is a graph for explaining problems of conventional information recording media;

FIG. 6 is a schematic diagram for explaining problems of conventional information recording media;

FIG. 7 is a graph for explaining the principle of the present invention;

FIG. 8 is a schematic diagram for explaining the principle of the present invention;

FIG. 9 is a table showing embodiments in accordance with the present invention;

FIG. 10 is a table showing embodiments in accordance with the present invention;

FIG. 11 is an explanatory drawing of a sputtering apparatus which is used in an embodiment of the present invention;

FIG. 12 is a table showing sputtering conditions which are used in an embodiment of the present invention; and

FIG. 13 is a block diagram showing an information recording/reproducing device which is used for evaluating the information recording media in accordance with the present invention.

### DESCRIPTION OF THE EMBODIMENTS

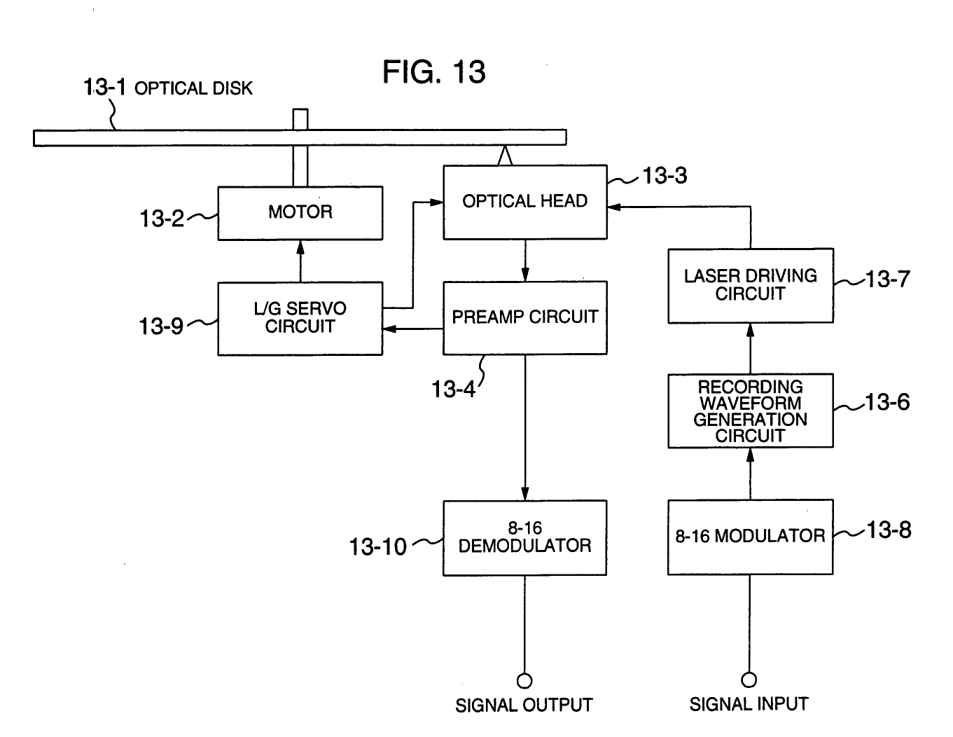

Referring now to the drawings, a description will be given in detail of preferred embodiments in accordance with the present invention. In performance measurement of information recording media of the following embodiments, “inner radius jitter” (jitter at the inner radius of the information recording medium after random signal recording of ten times) and “outer radius jitter” (jitter at the outer radius of the information recording medium after random signal recording of ten times) were measured using an information recording device of FIG. 13 and under evaluation conditions which will be described later. Further, in order to evaluate the effect of the dissolution of interface layer material into the recording layer, the difference between 11T amplitude after signal recording of 10 times and the 11T amplitude after signal recording of 10,000 times at the inner radius (hereafter, referred to as “amplitude deterioration”) was measured. Incidentally, the so-called “land-groove recording” is employed for the information recording medium of each embodiment. Therefore, an average value was taken in each measurement between two cases: a first case where information was recorded on lands; and a second case where information was recorded in grooves, and the average value will be shown below. The target value of each performance is as follows.
inner radius jitter: 9% or less
outer radius jitter: 9% or less
amplitude deterioration: 2 dB or less

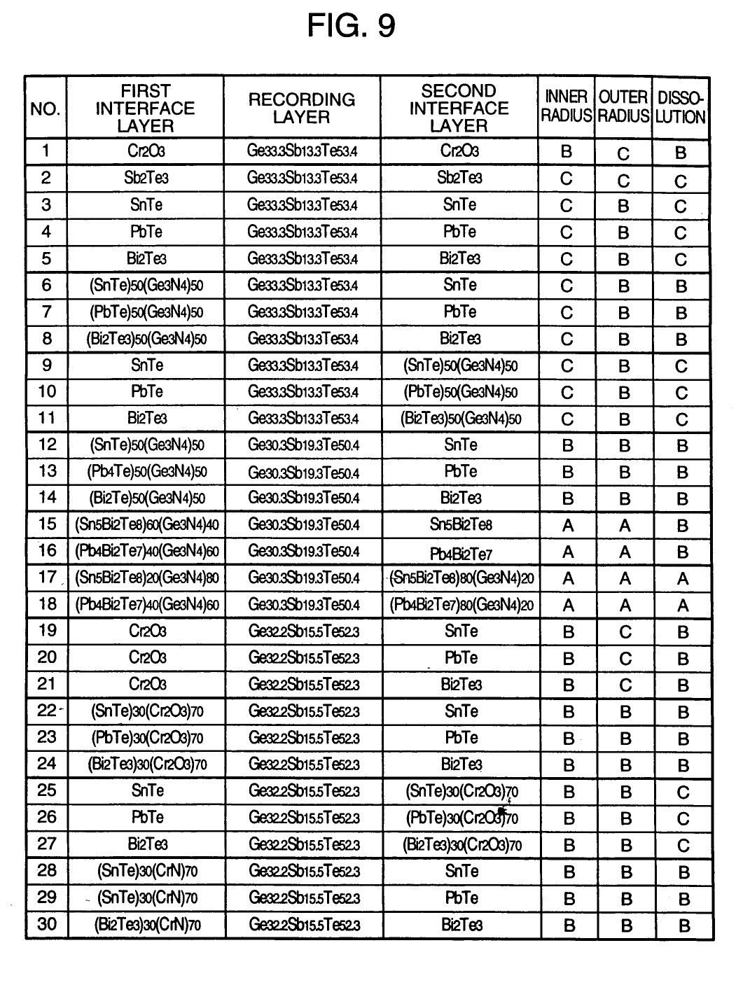

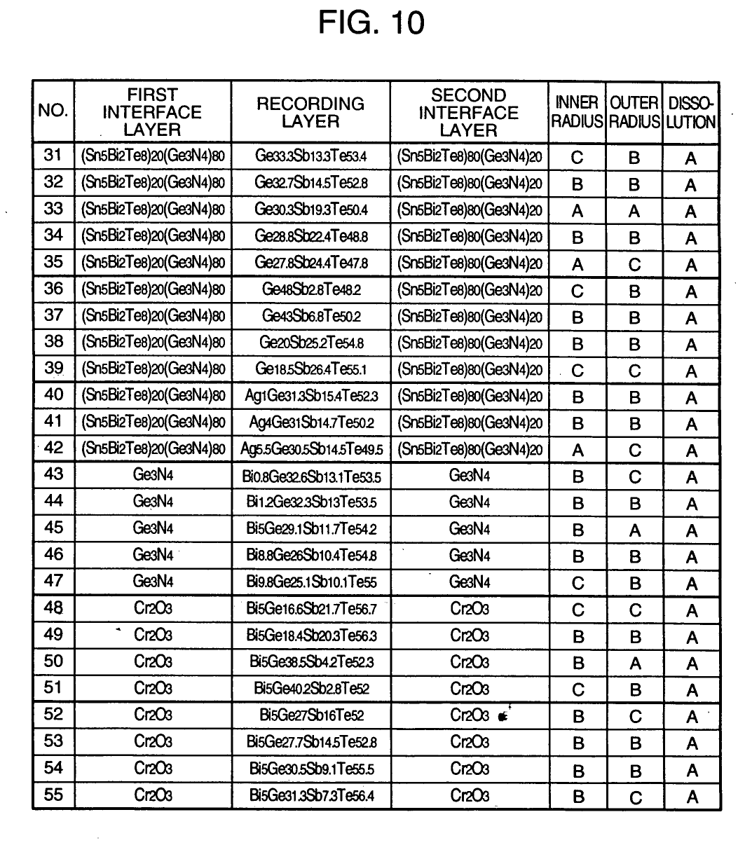

In FIGS. 9 and 10, evaluation results of the following embodiments are shown by use of “A”, “B” and “C”, in which criteria of judgment are as follows.
A: inner/outer radius jitter of 8% or less, or amplitude deterioration of 1 dB or less
B: inner/outer radius jitter of 9% or less, or amplitude deterioration of 2 dB or less
C: inner/outer radius jitter of over 9%, or amplitude deterioration of over 2 dB

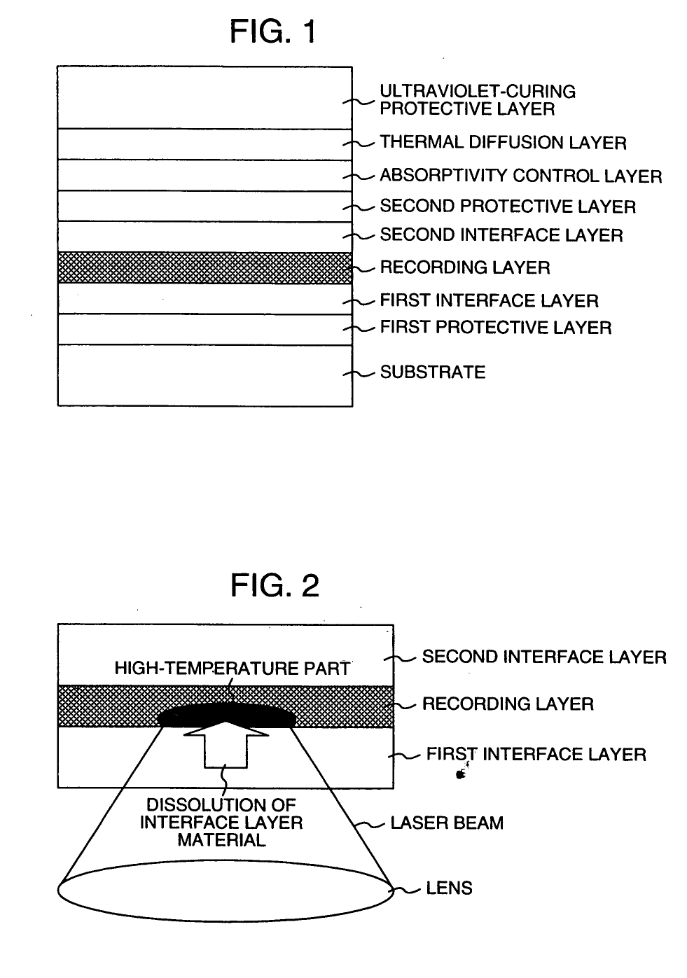

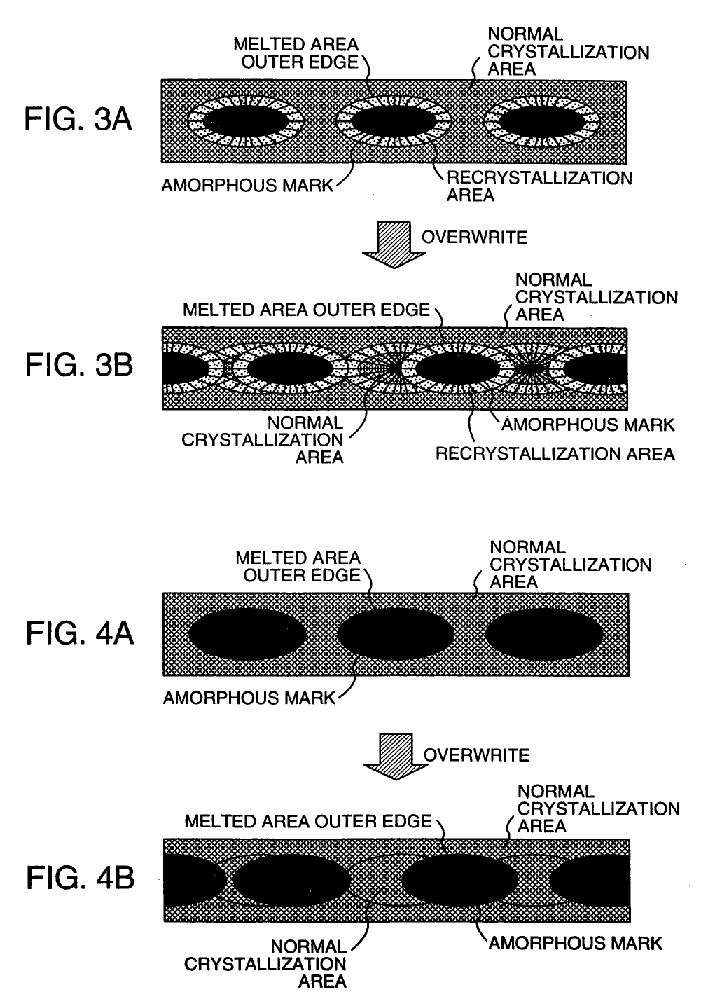

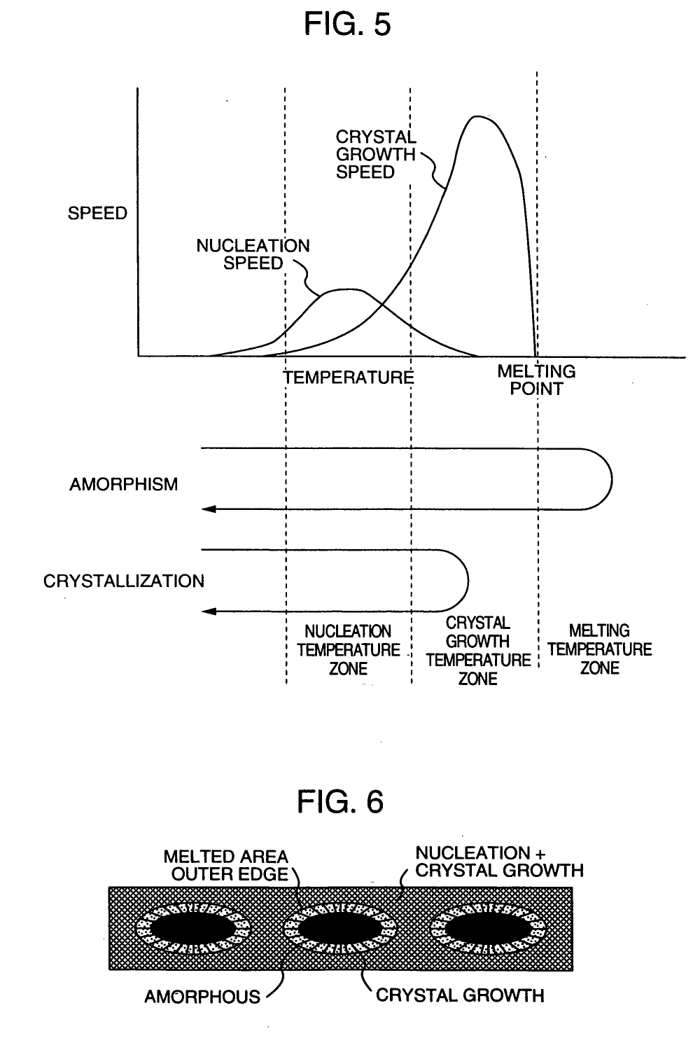

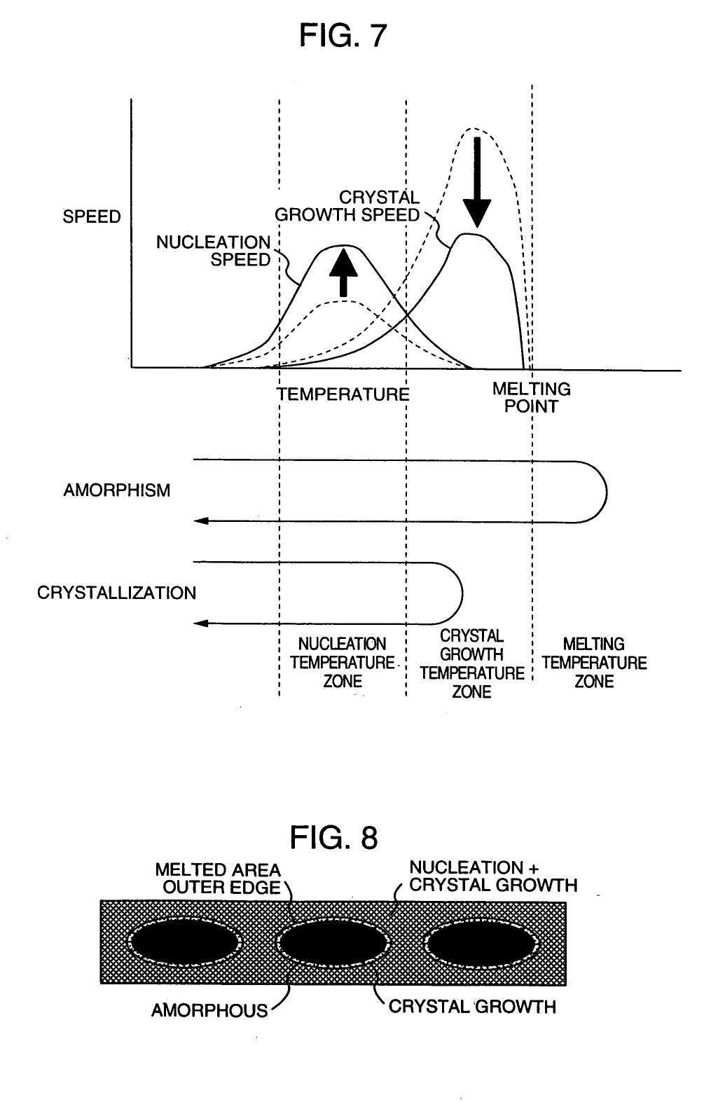

FIG. 1 is a schematic diagram showing the basic composition of the information recording medium in accordance with the present invention. Referring to FIG. 1, a first protective layer, a first interface layer, a recording layer, a second interface layer, a second protective layer, an absorptivity control layer, a thermal diffusion layer, and an ultraviolet-curing protective layer are successively deposited and stacked up on a substrate. As the substrate, a polycarbonate substrate of 0.6 mm thick was used. On the substrate, grooves according to the format of 4.7 GB DVD-RAM and the pre-pit shape were preliminarily formed.

### Embodiment 1

First, as a control group, evaluation results of an information recording medium which was experimentally manufactured so as to have the conventional composition will be shown. By means of sputtering processes, the first protective layer of (ZnS)₈₀ (SiO₂)₂₀ was deposited on the substrate to a film thickness of 120 nm, the first interface layer of Cr₂O₃ was deposited thereon to a film thickness of 3 nm, the recording layer of Ge_{33.3}Sb_{13.3}Te_{53.4} was deposited thereon to a film thickness of 8 nm, the second interface layer of Cr₂O₃ was deposited thereon to a film thickness of 1.5 nm, the second protective layer of (ZnS)₈₀(SiO₂)₂₀ was deposited thereon to a film thickness of 30 nm, the absorptivity control layer of Cr₉₀(Cr₂O₃)₁₀ was deposited thereon to a film thickness of 35 nm, and the thermal diffusion layer of Al₉₉Ti₁ was deposited thereon to a film thickness of 160 nm.

In the performance evaluation of the above information recording medium, the inner radius jitter and the amplitude deterioration satisfied the target values but the outer radius jitter did not satisfy the target value as shown in a number 1 of FIG. 9.

Next, when the first and second interface layers were formed of Sb₂Te₃, none of the performance items could satisfy the target value as shown in a number 2 of FIG. 9.

Next, when the first and second interface layers were formed of SnTe, the outer radius jitter satisfied the target value but the inner radius jitter and the amplitude deterioration did not satisfy the target values as shown in a number 3 of FIG. 9.

Next, when the first and second interface layers were formed of PbTe, the outer radius jitter satisfied the target value but the inner radius jitter and the amplitude deterioration did not satisfy the target values as shown in a number 4 of FIG. 9.

Next, when the first and second interface layers were formed of Bi₂Te₃, the outer radius jitter satisfied the target value but the inner radius jitter and the amplitude deterioration did not satisfy the target values as shown in a number 5 of FIG. 9.

As above, it was impossible to attain both “high playback signal quality in CAV recording” and “suppression of the amplitude deterioration after frequent rewriting” by the conventional composition of the information recording medium.

### Embodiment 2

By means of sputtering processes, the first protective layer of (ZnS)₈₀(SiO₂)₂₀ was deposited on the substrate to a film thickness of 120 nm, the first interface layer which will be explained below was deposited thereon to a film thickness of 3 nm, the recording layer of Ge_{33.3}Sb_{13.3}Te_{53.4} was deposited thereon to a film thickness of 8 nm, the second interface layer which will be explained below was deposited thereon to a film thickness of 1.5 nm, the second protective layer of (ZnS)₈₀(SiO₂)₂₀ was deposited thereon to a film thickness of 30 nm, the absorptivity control layer of Cr₉₀(Cr₂O₃)₁₀ was deposited thereon to a film thickness of 35 nm, and the thermal diffusion layer of Al₉₉Ti₁ was deposited thereon to a film thickness of 60 nm.

In the above composition, when the first interface layer was formed of (SnTe)₅₀(Ge₃N₄)₅₀ and the second interface layer was formed of SnTe, the inner radius jitter did not satisfy the target value but the outer radius jitter and the amplitude deterioration satisfied the target values as shown in a number 6 of FIG. 9.

Next, when the first interface layer was formed of (PbTe)₅₀(Ge₃N₄)₅₀ and the second interface layer was formed of PbTe, the inner radius jitter did not satisfy the target value but the outer radius jitter and the amplitude deterioration satisfied the target values as shown in a number 7 of FIG. 9.

Next, when the first interface layer was formed of (Bi₂Te₃)₅₀ (Ge₃N₄)₅₀ and the second interface layer was formed of Bi₂Te₃, the inner radius jitter did not satisfy the target value but the outer radius jitter and the amplitude deterioration satisfied the target values as shown in a number 8 of FIG. 9.

As above, by setting the content of Sn, Pb and Bi in the first interface layer lower than that in the second interface layer, the amplitude deterioration which is caused by the dissolution of interface layer material into the recording layer can be suppressed. However, the inner radius jitter in the CAV recording could not be reduced enough by the above composition.

### Embodiment 3

By means of sputtering processes, the first protective layer of (ZnS)₈₀(SiO₂)₂₀ was deposited on the substrate to a film thickness of 120 nm, the first interface layer which will be explained below was deposited thereon to a film thickness of 3 nm, the recording layer of Ge_{33.3}Sb_{13.3}Te_{53.4} was deposited thereon to a film thickness of 8 nm, the second interface layer which will be explained below was deposited thereon to a film thickness of 1.5 nm, the second protective layer of (ZnS)₈₀(SiO₂)₂₀ was deposited thereon to a film thickness of 30 nm, the absorptivity control layer of Cr₉₀(Cr₂O₃)₁₀ was deposited thereon to a film thickness of 35 nm, and the thermal diffusion layer of Al₉₉Ti₁ was deposited thereon to a film thickness of 60 nm.

In the above composition, when the first interface layer was formed of SnTe and the second interface layer was formed of (SnTe)₅₀(Ge₃N₄)₅₀, the outer radius jitter satisfied the target value but the inner radius jitter and the amplitude deterioration did not satisfy the target values as shown in a number 9 of FIG. 9.

Next, when the first interface layer was formed of PbTe and the second interface layer was formed of (PbTe)₅₀(Ge₃N₄)₅₀, the outer radius jitter satisfied the target value but the inner radius jitter and the amplitude deterioration did not satisfy the target values as shown in a number 10 of FIG. 9.

Next, when the first interface layer was formed of Bi₂Te₃ and the second interface layer was formed of (Bi₂Te₃)₅₀(Ge₃N₄)₅₀, the outer radius jitter satisfied the target value but the inner radius jitter and the amplitude deterioration did not satisfy the target values as shown in a number 11 of FIG. 9.

As above, when the content of Sn, Pb and Bi in the first interface layer lower is set higher than that in the second interface layer, the amplitude deterioration which is caused by the dissolution of interface layer material into the recording layer increases. Further, the inner radius jitter in the CAV recording could not be reduced enough by the above composition.

### Embodiment 4

By means of sputtering process, the first protective layer of (ZnS)₈₀(SiO₂)₂₀ was deposited on the substrate to a film thickness of 120 nm, the first interface layer which will be explained below was deposited thereon to a film thickness of 3 nm, the recording layer of Ge_{30.3}Sb_{19.3}Te_{50.4} was deposited thereon to a film thickness of 8 nm, the second interface layer which will be explained below was deposited thereon to a film thickness of 1.5 nm, the second protective layer of (ZnS)₈₀(SiO₂)₂₀ was deposited thereon to a film thickness of 30 nm, the absorptivity control layer of Cr₉₀(Cr₂O₃)₁₀ was deposited thereon to a film thickness of 35 nm, and the thermal diffusion layer of Al₉₉Ti₁ was deposited thereon to a film thickness of 60 nm.

In the above composition, when the first interface layer was formed of (SnTe)₅₀(Ge₃N₄)₅₀ and the second interface layer was formed of SnTe, all the performance items satisfied the target values as shown in a number 12 of FIG. 9.

Next, when the first interface layer was formed of (PbTe)₅₀(Ge₃N₄)₅₀ and the second interface layer was formed of PbTe, all the performance items satisfied the target values as shown in a number 13 of FIG. 9.

Next, when the first interface layer was formed of (Bi₂Te₃)₅₀(Ge₃N₄)₅₀ and the second interface layer was formed of Bi₂Te₃, all the performance items satisfied the target values as shown in a number 14 of FIG. 9.

Next, when the first interface layer was formed of (Sn₅Bi₂Te₈)₆₀(Ge₃N₄)₄₀ and the second interface layer was formed of Sn₅Bi₂Te₈, all the performance items satisfied the target values as shown in a number 15 of FIG. 9. Especially, the inner radius jitter and the outer radius jitter were excellent.

Next, when the first interface layer was formed of (Pb₄Bi₂Te₇)₄₀(Ge₃N₄)₆₀ and the second interface layer was formed of Pb₄Bi₂Te₇, all the performance items satisfied the target values as shown in a number 16 of FIG. 9. Especially, the inner radius jitter and the outer radius jitter were excellent.

Next, when the first interface layer was formed of (Sn₅Bi₂Te₈)₂₀(Ge₃N₄)₈₀ and the second interface layer was formed of (Sn₅Bi₂Te₈)₈₀(Ge₃N₄)₂₀, all the performance items satisfied the target values as shown in a number 17 of FIG. 9. Further, the inner radius jitter, the outer radius jitter and the amplitude deterioration were all excellent.

Next, when the first interface layer was formed of (Pb₄Bi₂Te₇)₄₀(Ge₃N₄)₆₀ and the second interface layer was formed of (Pb₄Bi₂Te₇)₈₀(Ge₃N₄)₂₀, all the performance items satisfied the target values as shown in a number 18 of FIG. 9. Further, the inner radius jitter, the outer radius jitter and the amplitude deterioration were all excellent.

As above, by setting the content of Sn, Pb and Bi in the first interface layer lower than that in the second interface layer, the amplitude deterioration which is caused by the dissolution of interface layer material into the recording layer can be suppressed. Further, by adding an excessive amount of Sb to the recording layer, the recrystallization of the recording layer material could be suppressed and thereby the inner radius jitter in the CAV recording could be reduced enough. Further, by employing the Sn—Bi—Te-based materials or the Pb—Bi—Te-based materials for the interface layers, the inner radius jitter and the outer radius jitter can be reduced further in comparison with the cases where SnTe, PbTe or Bi₂Te₃ alone is used for the second interface layer. The phenomenon can be attributed to the increase of crystalline structure similarity between the recording layer material and the interface layer material. Concretely, the Ge—Sb—Te-based material employed here for the recording layer is a material that is obtained by mixing GeTe with Sb₂Te₃ in a proper mixture ratio and adding Sb etc. to the mixture excessively. The crystal systems of SnTe and PbTe are the same as that of GeTe, and the crystal system of Bi₂Te₃ is the same as that of Sb₂Te₃ since Ge, Sn and Pb belong to the same group of elements and Sb and Bi belong to the same group of elements. Therefore, the Sn—Bi—Te-based materials and the Pb—Bi—Te-based materials employed for the interface layers in this embodiment are materials having very high crystalline structure similarity to the Ge—Sb—Te-based material employed for the recording layer in this embodiment, and what is more, having high crystallinity.

Further, the above results made it clear that the amplitude deterioration can be suppressed more efficiently by adding the high-melting-point dielectric material such as Ge₃N₄ also to the second interface layer.

The present inventors experimentally manufactured another information recording medium having the same composition as a number 17 of FIG. 9 except that the thickness of the first interface layer was changed to 0.5 nm. In this example, the amplitude deterioration got much larger; however, by employing (SnO₂)₈₀(Cr₂O₃)₂₀ for the first protective layer, the amplitude deterioration decreased considerably to satisfy the target value.

Further, the present inventors manufactured still another information recording medium having the same composition as the number 17 of FIG. 9 except that the thickness of the second interface layer was changed to 0.5 nm. Also in this example, the amplitude deterioration got much larger; however, by employing (SnO₂)₉₀(ZnS)₁₀ for the first protective layer, the amplitude deterioration decreased considerably to satisfy the target value.

### Embodiment 5

By means of sputtering process, the first protective layer of (ZnS)₈₀(SiO₂)₂₀ was deposited on the substrate to a film thickness of 120 nm, the first interface layer which will be explained below was deposited thereon to a film thickness of 3 nm, the recording layer of Ge_{32.2}Sb_{15.5}Te_{52.3} was deposited thereon to a film thickness of 8 nm, the second interface layer which will be explained below was deposited thereon to a film thickness of 1.5 nm, the second protective layer of (ZnS)₈₀(SiO₂)₂₀ was deposited thereon to a film thickness of 30 nm, the absorptivity control layer of Cr₉₀(Cr₂O₃)₁₀ was deposited thereon to a film thickness of 35 nm, and the thermal diffusion layer of Al₉₉Ti₁ was deposited thereon to a film thickness of 60 nm.

In the above composition, when the first interface layer was formed of Cr₂O₃ and the second interface layer was formed of SnTe, the inner radius jitter and the amplitude deterioration satisfied the target values but the outer radius jitter did not satisfy the target value as shown in a number 19 of FIG. 9.

Next, when the first interface layer was formed of Cr₂O₃ and the second interface layer was formed of PbTe, the inner radius jitter and the amplitude deterioration satisfied the target values but the outer radius jitter did not satisfy the target value as shown in a number 20 of FIG. 9.

Next, when the first interface layer was formed of Cr₂O₃ and the second interface layer was formed of Bi₂Te₃, the inner radius jitter and the amplitude deterioration satisfied the target values but the outer radius jitter did not satisfy the target value as shown in a number 21 of FIG. 9.

As above, with the first interface layer including no element Sn, Pb, Bi, etc. having the recording layer crystallization promotion effect, the outer radius jitter could not satisfy the target value.

Next, when the first interface layer was formed of (SnTe)₃₀(Cr₂O₃)₇₀ and the second interface layer was formed of SnTe, all the performance items satisfied the target values as shown in a number 22 of FIG. 9.

Next, when the first interface layer was formed of (SnTe)₃₀(Cr₂O₃)₇₀ and the second interface layer was formed of PbTe, all the performance items satisfied the target values as shown in a number 23 of FIG. 9.

Next, when the first interface layer was formed of (Bi₂Te₃)₃₀(Cr₂O₃)₇₀ and the second interface layer was formed of Bi₂Te₃, all the performance items satisfied the target values as shown in a number 24 of FIG. 9.

As above, by setting the content of Sn, Pb and Bi in the first interface layer lower than that in the second interface layer, the amplitude deterioration which is caused by the dissolution of interface layer material into the recording layer can be suppressed. Further, by adding an excessive amount of Sb to the recording layer, the recrystallization of the recording layer material can be suppressed and thereby the inner radius jitter in the CAV recording can be reduced enough. Further, it became clear that the addition of transition metal oxides such as Cr₂O₃ is effective for the reduction of the elements Sn, Pb, Bi, etc. contained in the first interface layer.

Next, when the first interface layer was formed of SnTe and the second interface layer was formed of (SnTe)₃₀(Cr₂O₃)₇₀, the inner radius jitter and the outer radius jitter satisfied the target values but the amplitude deterioration did not satisfy the target value as shown in a number 25 of FIG. 9.

Next, when the first interface layer was formed of PbTe and the second interface layer was formed of (SnTe)₃₀(Cr₂O₃)₇₀, the inner radius jitter and the outer radius jitter satisfied the target values but the amplitude deterioration did not satisfy the target value as shown in a number 26 of FIG. 9.

Next, when the first interface layer was formed of Bi₂Te₃ and the second interface layer was formed of (Bi₂Te₃)₃₀(Cr₂O₃)₇₀, the inner radius jitter and the outer radius jitter satisfied the target values but the amplitude deterioration did not satisfy the target value as shown in a number 27 of FIG. 9.

As above, when the content of Sn, Pb and Bi in the first interface layer lower is set higher than that in the second interface layer, the amplitude deterioration due to the dissolution of interface layer material into the recording layer occurs. However, by adding an excessive amount of Sb to the recording layer, the recrystallization of the recording layer material can be suppressed and thereby the inner radius jitter in the CAV recording can be reduced enough.

Next, when the first interface layer was formed of (SnTe)₃₀(CrN)₇₀ and the second interface layer was formed of SnTe, all the performance items satisfied the target values as shown in a number 28 of FIG. 9.

Next, when the first interface layer was formed of (SnTe)₃₀(CrN)₇₀ and the second interface layer was formed of PbTe, all the performance items satisfied the target values as shown in a number 29 of FIG. 9.

Next, when the first interface layer was formed of (Bi₂Te₃)₃₀(CrN)₇₀ and the second interface layer was formed of Bi₂Te₃, all the performance items satisfied the target values as shown in a number 30 of FIG. 9.

As above, by setting the content of Sn, Pb and Bi in the first interface layer lower than that in the second interface layer, the amplitude deterioration which is caused by the dissolution of interface layer material into the recording layer can be suppressed. Further, by adding an excessive amount of Sb to the recording layer, the recrystallization of the recording layer material can be suppressed and thereby the inner radius jitter in the CAV recording can be reduced enough. Further, it became clear that the addition of transition metal oxides such as CrN is effective for the reduction of the elements Sn, Pb, Bi, etc. contained in the first interface layer.

### Embodiment 6

By means of sputtering process, the first protective layer of (ZnS)₈₀(SiO₂)₂₀ was deposited on the substrate to a film thickness of 120 nm, the first interface layer of (Sn₅Bi₂Te₈)₂₀ (Ge₃N₄)₈₀ was deposited thereon to a film thickness of 3 nm, the recording layer which will be explained below was deposited thereon to a film thickness of 8 nm, the second interface layer of (Sn₅Bi₂Te₈)₈₀(Ge₃N₄)₂₀ was deposited thereon to a film thickness of 1.5 nm, the second protective layer of (ZnS)₈₀(SiO₂)₂₀ was deposited thereon to a film thickness of 30 nm, the absorptivity control layer of Cr₉₀(Cr₂O₃)₁₀ was deposited thereon to a film thickness of 35 nm, and the thermal diffusion layer of Al₉₉Ti₁ was deposited thereon to a film thickness of 60 nm.

In the above composition, when the recording layer was formed of Ge_{33.3}Sb_{13.3}Te_{53.4}, the outer radius jitter and the amplitude deterioration satisfied the target values but the inner radius jitter did not satisfy the target value as shown in a number 31 of FIG. 10.

Next, when the recording layer was formed of Ge_{32.7}Sb_{14.5}Te_{52.8}, all the performance items satisfied the target values as shown in a number 32 of FIG. 10.

Next, when the recording layer was formed of Ge_{30.3}Sb_{19.3}Te_{50.4}, all the performance items satisfied the target values as shown in a number 33 of FIG. 10. Further, both the inner radius jitter and the outer radius jitter exhibited excellent figures clearing the target values by more than 1%.

Next, when the recording layer was formed of Ge_{28.8}Sb_{22.4}Te_{48.8}, all the performance items satisfied the target values as shown in a number 34 of FIG. 10.

Next, when the recording layer was formed of Ge_{27.8}Sb_{24.4}Te_{47.8}, the inner radius jitter and the amplitude deterioration satisfied the target values but the outer radius jitter did not satisfy the target value as shown in a number 35 of FIG. 10.

As above, the inner radius jitter can not be suppressed enough if the recording layer does not include an excessive amount of Sb relative to the content of GeTe and Sb₂Te₃; however, too much addition of Sb causes the increase of the outer radius jitter. Therefore, in the following compositional formula of the recording layer, it is desirable that Y should be set between 0.5 and 5.
Ge_{X-Y}Sb_{40-0.8X+2Y}Te_{60-0.2X-Y}
(20<X<45, 0.5<Y<5)

### Embodiment 7

By means of sputtering process, the first protective layer of (ZnS)₈₀(SiO₂)₂₀ was deposited on the substrate to a film thickness of 120 nm, the first interface layer of (Sn₅Bi₂Te₈)₂₀(Ge₃N₄)₈₀ was deposited thereon to a film thickness of 3 nm, the recording layer which will be explained below was deposited thereon to a film thickness of 8 nm, the second interface layer of (Sn₅Bi₂Te₈)₈₀(Ge₃N₄)₂₀ was deposited thereon to a film thickness of 1.5 nm, the second protective layer of (ZnS)₈₀(SiO₂)₂₀ was deposited thereon to a film thickness of 30 nm, the absorptivity control layer of Cr₉₀(Cr₂O₃)₁₀ was deposited thereon to a film thickness of 35 nm, and the thermal diffusion layer of Al₉₉Ti₁ was deposited thereon to a film thickness of 60 nm.

In the above composition, when the recording layer was formed of Ge₄₈Sb_{2.8}Te_{49.2}, the outer radius jitter and the amplitude deterioration satisfied the target values but the inner radius jitter did not satisfy the target value as shown in a number 36 of FIG. 10.

Next, when the recording layer was formed of Ge₄₃Sb_{6.8}Te_{50.2}, all the performance items satisfied the target values as shown in a number 37 of FIG. 10.

Next, when the recording layer was formed of Ge₂₀Sb_{25.2}Te_{54.8}, all the performance items satisfied the target values as shown in a number 38 of FIG. 10.

Next, when the recording layer was formed of Ge_{18.5}Sb_{26.4}Te_{55.1}, all the performance items satisfied the target values as shown in a number 39 of FIG. 10.

As above, in the case where GeTe and Sb₂Te₃ are mixed together in the recording layer, it became clear that X in the compositional formula of the recording layer should be set between 20 and 45.
Ge_{X-Y}Sb_{40-0.8X+2Y}Te_{60-0.2X-Y}
(20<X<45, 0.5<Y<5)

The cause of the above result is as follows. If the mixture ratio of GeTe is too high, the crystal growth speed becomes high and thereby the recrystallization is caused. On the other hand, if the mixture ratio of GeTe is too low, the difference of refractive index between crystal and amorphous becomes too small and thereby the playback signal amplitude becomes insufficient.

### Embodiment 8

By means of sputtering processes, the first protective layer of (ZnS)₈₀(SiO₂)₂₀ was deposited on the substrate to a film thickness of 120 nm, the first interface layer of (Sn₅Bi₂Te₈)₂₀(Ge₃N₄)₈₀ was deposited thereon to a film thickness of 3 nm, the recording layer, which will be explained below, was deposited thereon to a film thickness of 8 nm, the second interface layer of (Sn₅Bi₂Te₈)₈₀(Ge₃N₄)₂₀ was deposited thereon to a film thickness of 1.5 nm, the second protective layer of (ZnS)₈₀(SiO₂)₂₀ was deposited thereon to a film thickness of 30 nm, the absorptivity control layer of Cr₉₀(Cr₂O₃)₁₀ was deposited thereon to a film thickness of 35 nm, and the thermal diffusion layer of Al₉₉Ti₁ was deposited thereon to a film thickness of 60 nm.

In the above composition, when the recording layer was formed of Ag₁Ge_{31.3}Sb_{15.4}Te_{52.3}, the outer radius jitter and the amplitude deterioration satisfied the target values but the inner radius jitter did not satisfy the target value as shown in a number 40 of FIG. 10.

Next, when the recording layer was formed of Ag₄Ge₃₁Sb_{14.7}Te_{50.2}, all the performance items satisfied the target values as shown in a number 41 of FIG. 10.

Next, when the recording layer was formed of Ag_{5.5}Ge_{30.5}Sb_{14.5}Te_{49.5}, the inner radius jitter and the amplitude deterioration satisfied the target values but the outer radius jitter did not satisfy the target value as shown in a number 42 of FIG. 10.

As above, satisfactory performance can also be obtained by employing the GeTe and Sb₂Te₃ mixture composition for the recording layer and adding metal such as Ag by about 1 to 5%. Metals other than Ag, such as Cr, Si, Ga, Al, In, B and N, can also exhibit satisfactory performance. The above results made it clear that Z in the following compositional formula of the recording layer should be set about 0.5 to 5%.
(Ge_{X-Y}Sb_{40-0.8X+2Y}Te_{60-0.2X-Y})_{100-Z}M_{Z}
(20<X<45, 0.5<Y<5, 0.5<Z<5)
(M is an element selected from Ag, Cr, Si, Ga, Al, In, B and N)

### Embodiment 9

By means of sputtering process, the first protective layer of (ZnS)₈₀(SiO₂)₂₀ was deposited on the substrate to a film thickness of 120 nm, the first interface layer of Ge₃N₄ was deposited thereon to a film thickness of 3 nm, the recording layer, which will be explained below, was deposited thereon to a film thickness of 8 nm, the second interface layer of Ge₃N₄ was deposited thereon to a film thickness of 1.5 nm, the second protective layer of (ZnS)₈₀(SiO₂)₂₀ was deposited thereon to a film thickness of 30 nm, the absorptivity control layer of Cr₉₀(Cr₂O₃)₁₀ was deposited thereon to a film thickness of 35 nm, and the thermal diffusion layer of Al₉₉Ti₁ was deposited thereon to a film thickness of 60 nm.

In the above composition, when the recording layer was formed of Bi_{0.8}Ge_{32.6}Sb_{13.1}Te_{53.5}, the inner radius jitter and the amplitude deterioration satisfied the target values but the outer radius jitter did not satisfy the target value as shown in a number 43 of FIG. 10.

Next, when the recording layer was formed of Bi_{1.2}Ge_{32.3}Sb₁₃Te_{53.5}, all the performance items satisfied the target values as shown in a number 44 of FIG. 10.

Next, when the recording layer was formed of Bi₅Ge_{29.1}Sb_{11.7}Te_{54.2}, all the performance items satisfied the target values as shown in a number 45 of FIG. 10.

Next, when the recording layer was formed of Bi_{8.8}Ge₂₆Sb_{10.4}Te_{54.8}, all the performance items satisfied the target values as shown in a number 46 of FIG. 10.

Next, when the recording layer was formed of Bi_{9.8}Ge_{25.1}Sb_{10.1}Te₅₅, the outer radius jitter and the amplitude deterioration satisfied the target values but the inner radius jitter did not satisfy the target value as shown in a number 47 of FIG. 10.

As above, when Bi₂Te₃ is added to the recording layer employing the GeTe and Sb₂Te₃ mixture composition, excellent CAV recording performance can be obtained even if the elements Sn, Pb, Bi, etc. having the recording layer crystallization promotion effect are not added to the first interface layer and the second interface layer. The above results made it clear that Z in the following compositional formula of the recording layer should be set about 2.5 to 25%.
(Ge_{X-Y}Sb_{40-0.8X+2Y}Te_{60-0.2X-Y})_{100-Z}(Bi₂Te₃)_{Z}
(20<X<45, −2<Y<2, 2.5<Z<25)

### Embodiment 10

By means of sputtering process, the first protective layer of (ZnS)₈₀(SiO₂)₂₀ was deposited on the substrate to a film thickness of 120 nm, the first interface layer of Cr₂O₃ was deposited thereon to a film thickness of 3 nm, the recording layer, which will be explained below, was deposited thereon to a film thickness of 8 nm, the second interface layer of Cr₂O₃ was deposited thereon to a film thickness of 1.5 nm, the second protective layer of (ZnS)₈₀(SiO₂)₂₀ was deposited thereon to a film thickness of 30 nm, the absorptivity control layer of Cr₉₀(Cr₂O₃)₁₀ was deposited thereon to a film thickness of 35 nm, and the thermal diffusion layer of Al₉₉Ti₁ was deposited thereon to a film thickness of 60 nm.

In the above composition, when the recording layer was formed of Bi₅Ge_{16.6}Sb_{21.7}Te_{56.7}, both the inner radius jitter and the outer radius jitter did not satisfy the target values as shown in a number 48 of FIG. 10.

Next, when the recording layer was formed of Bi₅Ge_{18.4}Sb_{20.3}Te_{56.3}, all the performance items satisfied the target values as shown in a number 49 of FIG. 10.

Next, when the recording layer was formed of Bi₅Ge_{38.5}Sb_{40.2}Te_{52.3}, all the performance items satisfied the target values as shown in a number 50 of FIG. 10.

Next, when the recording layer was formed of Bi₅Ge_{40.2}Sb_{2.8}Te₅₂, the outer radius jitter satisfied the target value but the inner radius jitter did not satisfy the target value as shown in a number 51 of FIG. 10.

As above, when Bi₂Te₃ is added to the recording layer employing the GeTe and Sb₂Te₃ mixture composition, excellent CAV recording performance can be obtained even if the elements Sn, Pb, Bi, etc. having the recording layer crystallization promotion effect are not added to the first interface layer and the second interface layer. With regard to the mixture ratio between GeTe and Sb₂Te₃, the above results made it clear that X in the following compositional formula of the recording layer should be set about 20 to 45.
(Ge_{X-Y}Sb_{40-0.8X+2Y}Te_{60-0.2X-Y})_{100-Z}(Bi₂Te₃)_{Z}
(20<X<45, −2<Y<2, 2.5<Z<25)

Further, when the recording layer was formed of Bi₅Ge₂₇Sb₁₆Te₅₂, the inner radius jitter satisfied the target value but the outer radius jitter did not satisfy the target value as shown in a number 52 of FIG. 10.

Next, when the recording layer was formed of Bi₅Ge_{27.7}Sb_{14.5}Te_{52.8}, all the performance items satisfied the target values as shown in a number 53 of FIG. 10.

Next, when the recording layer was formed of Bi₅Ge_{30.5}Sb_{9.1}Te_{55.5}, all the performance items satisfied the target values as shown in a number 54 of FIG. 10.

Next, when the recording layer was formed of Bi₅Ge_{31.3}Sb_{7.3}Te_{56.4}, the inner radius jitter satisfied the target value but the outer radius jitter did not satisfy the target value as shown in a number 55 of FIG. 10.

As above, when Bi₂Te₃ is added to the recording layer employing the GeTe and Sb₂Te₃ mixture composition, excellent CAV recording performance can be obtained even if the elements Sn, Pb, Bi, etc. having the recording layer crystallization promotion effect are not added to the first interface layer and the second interface layer. With regard to the mixture ratio between GeTe and Sb₂Te₃, the above results made it clear that Y in the following compositional formula of the recording layer should be set about −2 to 2.
(Ge_{X-Y}Sb_{40-0.8X+2Y}Te_{60-0.2X-Y})_{100-Z}(Bi₂Te₃)_{Z}
(20<X<45, −2<Y<2, 2.5<Z<25)

### Embodiment 11

<Sputtering Apparatus>

As the sputtering apparatus for manufacturing the information recording media in accordance with the present invention, the so-called “sheet-fed sputtering apparatus” having a plurality of chambers is suitable, in which each chamber is provided with a sputtering target, and a substrate for the fabrication of the information recording medium is successively transferred through the chambers.

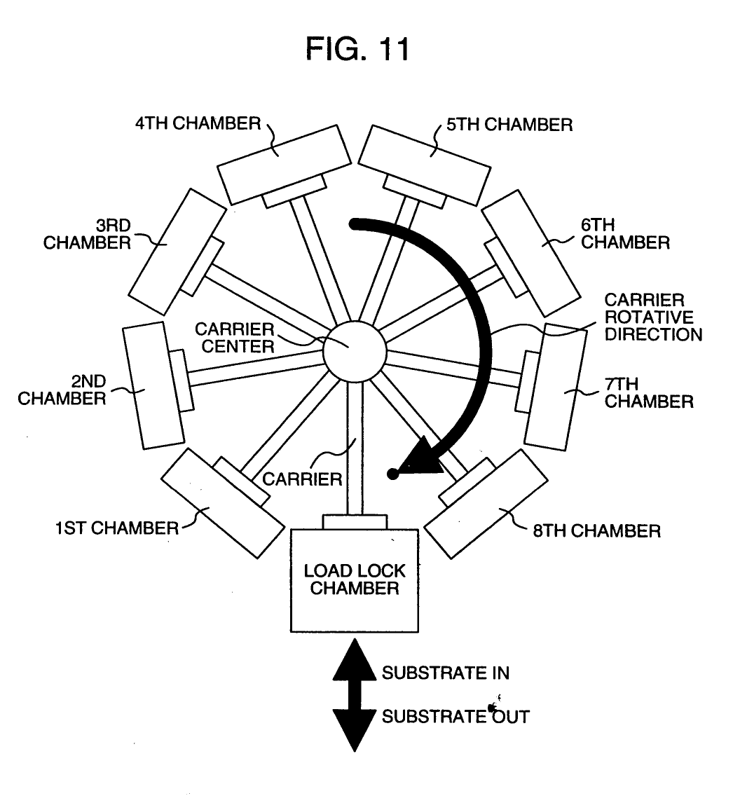

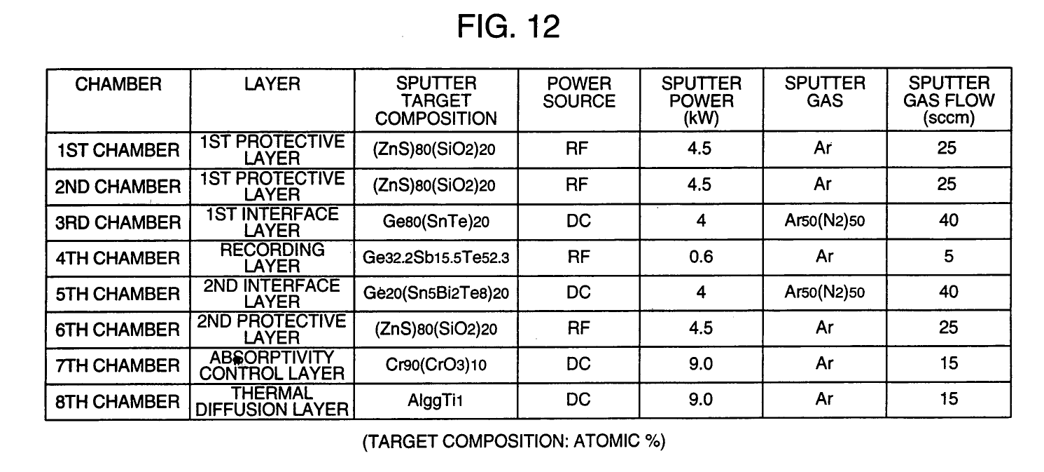

In the following, the structure of the sputtering apparatus for the manufacture of the information recording medium of the present invention will be explained in detail referring to FIG. 11. The sputtering apparatus of FIG. 11 is provided with nine chambers including eight “process chambers,” 1st through 8th chambers, to be used for the deposition processes and one “load lock chamber” to be used for loading the substrate in the sputtering apparatus and taking the information recording medium out of the sputtering apparatus after the deposition processes. The sputtering apparatus is provided with nine, the same as the number of the chambers, carriers which rotate around a carrier center or rotation axis in the direction of the arrow shown in FIG. 11, thereby the substrates are successively transferred through the chambers.

Each process chamber is provided with a sputtering power supply that is suitable for the formation of each layer, a plurality of sputtering gas pipes and massflow controllers for controlling the flow of sputtering gases, etc. After each substrate is placed and set in each chamber, a sputtering gas suitable for each chamber is fed into each chamber, and thereafter sputtering is carried out in each chamber. The carrier for carrying each substrate is provided with a compact vacuum motor for rotating the substrate. Since no power cable can be used for the power supply to the vacuum motor, each carrier is designed to make contact with each chamber when the carrier is set in the chamber so that power can be supplied through the contact point or interface. Thanks to the substrate rotation, uniformity of the composition and thickness of each layer formed on the substrate can be improved considerably. Further, the sputtering apparatus is provided with structure for letting He gas for cooling the substrate flow between the substrate and the carrier for preventing the substrate from overheating during sputtering, therefore, substrate deformation due to overheating can generally be avoided.

<Example of Manufacture of Information Recording Medium>

On a polycarbonate substrate for the land-groove recording (thickness: 0.6 mm thick, track pitch: 0.615 μm, groove depth: 65 nm) on which address information to be used for recording information both on the lands and in the grooves has been recorded at the head of each sector, a first protective layer: (ZnS)₈₀ (SiO₂)₂₀ (124 nm), a first interface layer: (Ge₃N₄)₈₀(SnTe)₂₀ (3 nm), a recording layer: Ge_{32.2}Sb_{15.5}Te_{52.3} (9 nm), a second interface layer: (SnTe)₈₀(Ge₃N₄)₂₀ (1.5 nm), a second protective layer: (ZnS)₈₀(SiO₂)₂₀ (30 nm), an absorptivity control layer: Cr₉₀(Cr₂O₃)₁₀ (35 nm), and a thermal diffusion layer: Al₉₉Ti₁ (60 nm) were deposited successively. For the deposition of the above layers, the aforementioned mass production sputtering apparatus having eight process chambers was used. Sputtering conditions employed in the deposition processes are summarized in FIG. 12. Distinctive features of the sputtering conditions are that the first interface layer (Ge₃N₄)₈₀(SnTe)₂₀ and the second interface layer (SnTe)₈₀(Ge₃N₄)₂₀ are deposited by use of a (Ge)₈₀(SnTe)₂₀ target and a (Ge)₂₀(Sn₅Bi₂Te₈)₈₀ target respectively and by means of reactive sputtering with nitrogen gas. By such conditions, the low-melting-point elements Sn, Pb, Bi, etc. and Ge₃N₄ can easily be mixed together and the nitrogen content in the interface layers can be controlled easily.

According to experiments conducted by the present inventors, the increase of the nitrogen content in the sputtering gas causes the increase of transparency of the interface layer, in addition to the suppression of the dissolution of Sn, Pb and Bi into the recording layer. However, the recording layer crystallization promotion effect is deteriorated by the increase of the nitrogen content. An effective strategy for this case is, for example, to set the nitrogen content in the sputtering gas high in the 3rd chamber for the deposition of the first interface layer and low in the 5th chamber for the deposition of the second interface layer. As above, thanks to the easy control of the nitrogen content in the sputtering gas, the dissolution of interface layer elements into the recording layer and the recording layer crystallization promotion effect can be controlled very easily and quickly.

### Embodiment 12

In the following, information reading/writing on the information recording medium of the present invention and the operation of an information recording device will be described referring to FIG. 13. As a motor control method for the information reading/writing in this embodiment, the CAV, in which the disk revolving speed is maintained constant regardless of the read/write zone on the disk, is employed. In this example, the disk linear velocity is 8.2 m/sec at the innermost track (radius: 24 mm) and 20 m/sec at the outermost track (radius: 58.5 mm). Incidentally, the term “inner radius” in this description basically denotes a radius of approximately 24 mm and the term “outer radius” basically denotes a radius of approximately 58.5 mm.

First, the reading/writing process will be explained. Information supplied from outside the information recording device is first inputted to a 8-16 modulator 13-8 in units of 8 bits. The information recording on the information recording medium (hereafter, referred to as “optical disk 13-1”) is carried out employing the so-called 8-16 modulation method of modulating 8-bit information into 16 bits. In the 8-16 modulation, marks or mark length: 3T to 14T corresponding to the 8-bit information are recorded on the recorded on the medium or optical disk 13-1. The 8-16 modulator 13-8 in FIG. 13 executes the modulation. Incidentally, the above “T” means the clock cycle which is employed in the information recording. In this example, T was set to 17.1 ns at the innermost track and 7 ns at the outermost track.

The 3T to 14T digital signals obtained by the modulation by the 8-16 modulator 13-8 are supplied to a recording waveform generation circuit 13-6, and a multi-pulse recording waveform is generated by the recording waveform generation circuit 13-6. In the multi-pulse recording waveform, the pulse width of each high power pulse (for high power level laser irradiation) is set to approximately T/2, and a low power pulse for low power level laser irradiation having a pulse width of approximately T/2 is inserted between the high power pulses one by one so as to form a high power pulse sequence. Between two high power pulse sequences, a middle power pulse for middle power level laser irradiation is inserted. In the process, the high power level for the formation of record marks and the middle power level capable of crystallizing the record marks were adjusted to optimum levels depending on the measured medium and the radial position. The recording waveform generation circuit 13-6 associates the 3T to 14T signals with data “0” and “1” on the time series alternately, and outputs the middle power pulse for the emission of a middle power laser beam if the data is “0” and the high power pulse sequence including the high power pulses for the emission of a high power laser beam sequence if the data is “1”. Part on the optical disk 13-1 irradiated with the middle power laser beam turns into crystalline, and part on the optical disk 13-1 irradiated with the high power laser beam sequence turns into amorphous (mark section). When the high power pulse sequence including the high power pulses for the formation of the mark section is generated, the recording waveform generation circuit 13-6 refers to its multi-pulse waveform table that supports a particular waveform control method (adaptive recording waveform control). In the adaptive recording waveform control, the pulse widths of pulses at the front end and rear end of the high power pulse sequence are changed depending on the lengths of spaces before and after the mark section, thereby a multi-pulse recording waveform capable of minimizing the effects of thermal interference between the marks is generated by the recording waveform generation circuit 13-6.

The recording waveform generated by the recording waveform generation circuit 13-6 is supplied to a laser driving circuit 13-7. The laser driving circuit 13-7 drives a semiconductor laser of an optical head 13-3 on the basis of the recording waveform, thereby the aforementioned laser beams are emitted by the semiconductor laser. The optical head 13-3 of the information recording device is equipped with a 655 nm semiconductor laser for the information recording. The laser beams emitted by the semiconductor laser according to the recording waveform were converged by an object lens (lens NA (Numerical Aperture)=0.6) and focused on the recording layer of the optical disk 13-1 and thereby the information recording was carried out.

Generally, when a laser beam of a wavelength “λ” is converged by a lens of a numerical aperture “NA”, the spot diameter of the laser beam can be expressed as 0.9 λ/NA, therefore, the laser beam spot diameter becomes approximately 0.98 μm under the above conditions. The polarization of the laser beam was circular polarization.

The information recording device supports the aforementioned land-groove recording, in which information is recorded both in grooves and on lands (areas between the grooves). An L/G servo circuit 13-9 of the information recording device has a function for making a selection between land tracking and groove tracking. The playback or reproduction of the recorded information was also carried out using the optical head 13-3. The playback signal is obtained by irradiating the recorded marks with a laser beam and detecting reflected light from the marks and parts other than the marks. The amplitude of the playback signal is enhanced by a preamp circuit 13-4, and the amplified playback signal is supplied to an 8-16 demodulator 13-10. The 8-16 demodulator 13-10 carries out demodulation of the playback signal in units of 16 bits and thereby converts the 16-bit playback signal into 8-bit information, thereby the playback of the recorded marks is completed. In the information recording on the optical disk 13-1 under the above conditions, the mark lengths of 3T mark as shortest mark and 14T mark (longest mark) are approximately 0.42 μm and 1.96 μm, respectively.

The measurement of the inner radius jitter and the outer radius jitter was carried out by recording a random pattern signal containing the 3T to 14T signals on the optical disk 13-1, playing back the random pattern signal, and conducting waveform equalization, binarization and a PLL (Phase Locked Loop) process to the playback signal. The measurement of the amplitude deterioration was carried out by repeatedly recording 11T signals on the optical disk 13-1 and obtaining the difference between the playback signal amplitude after signal recording of 10 times and that after signal recording of 10,000 times.

### Embodiment 13

In the following, the optimum composition and thickness of each layer that can be employed in the information recording medium of the present invention will be explained.

<First Protective Layer>

Material existing on the light-incident side of the first protective layer is a plastic substrate such as a polycarbonate substrate or organic material such as ultraviolet-curing resin, and the refractive index of such material is approximately 1.4 to 1.6. In order to effectively cause reflection at the interface between the organic material and the first protective layer, the refractive index of the first protective layer should be set to 2.0 or more. In the optical sense, the refractive index of the first protective layer should be higher than that of the material existing on the light-incident side (substrate in this embodiment), and should be as high as possible as long as light absorption can be avoided. Specifically, material with a refractive index n between 2.0 and 3.0 and without light absorption is desirable for the first protective layer, and is especially desirable if it includes oxide, carbide, nitride, sulfide and/or selenide of metal. Further, thermal conductivity of the material should be 2W/mk or less. Above all, ZnS—SiO₂-based compounds have low thermal conductivity and are the most suitable for the first protective layer. Further, SnO₂, SnO₂ doped with sulfide ZnS, CdS, SnS, GeS, PbS, etc. and SnO₂ doped with transition metal oxide SnO₂, Cr₂O₃, Mo₃O₄, etc. exhibit especially excellent characteristics as the first protective layer thanks to their low thermal conductivity and thermal stability higher than that of the ZnS—SiO₂-based material, since dissolution into the recording layer can be avoided even if the thickness of the first interface layer became 2 nm or less. From the viewpoint of the effective use of optical interference between the substrate and the recording layer, the optimum thickness of the first protective layer is 110 nm to 135 nm in the case where the laser beam wavelength is about 650 nm.

<First Interface Layer>

As discussed before in detail, it is desirable that the first interface layer contains material Bi, Sn, Pb, etc. having the recording layer crystallization promotion effect. Especially, telluride or oxide of Bi, Sn or Pb; a mixture of germanium nitride and telluride or oxide of Bi, Sn or Pb; and a mixture of transition metal oxide or transition metal nitride and telluride or oxide of Bi, Sn or Pb are suitable. Transition metal easily changes its valence, therefore, even when elements such as Bi, Sn, Pb and Te got liberated, the transition metal changes its valence and combines with the elements Bi, Sn, Pb and Te and thereby forms thermally stable compounds. Especially, Cr, Mo and W can be employed as excellent transition metals since they have high melting points and easily change their valences and thereby form thermally stable compounds with the elements. The content of the telluride or oxide of Bi, Sn or Pb in the first interface layer should be as high as possible in order to promote the crystallization of the recording layer; however, the first interface layer tends to be hotter than the second interface layer due to laser beam irradiation and problems such as the dissolution of the first interface layer material into the recording layer might occur. Therefore, the content of the telluride or oxide of Bi, Sn or Pb in the first interface layer should be set so as not to exceed 70%.

The first interface layer can achieve its effect if its thickness is 0.5 nm or more. However, when the thickness becomes below 2 nm, there are cases where the first protective layer material dissolves into the recording layer through the first interface layer and thereby the playback signal quality after frequent rewriting is deteriorated. Therefore, it is desirable that the thickness should be set to 2 nm or more. On the other hand, too much thickness over 10 nm might cause optical ill effects caused by deterioration of reflectivity, drop in signal amplitude, etc., therefore, desirable thickness of the first interface layer is 2 nm to 10 nm.

<Recording Layer>

As discussed before in detail, when the elements having the recording layer crystallization promotion effect Bi, Sn, Pb, etc. are added to both the first interface layer and the second interface layer, the aforementioned recording layer material comprised of the well-known Ge—Sb—Te-based recording layer material containing GeTe and Sb₂Te₃ in a proper mixture ratio and an excessive amount of Sb added thereto can be employed for the recording layer. Specifically, recording layer materials within the following compositional formula (atomic percent) are excellent.
Ge_{X-Y}Sb_{40-0.8X+2Y}Te_{60-0.2X-Y}
(20<X<45, 0.5<Y<5)

Other than the excessive doping with Sb, it is also possible to add elements capable of reducing the nucleation speed and the crystal growth speed. Specifically, recording layer materials within the following compositional formula (atomic percent) are excellent.
(Ge_{X-Y}Sb_{40-0.8X+2Y}Te_{60-0.2X-Y})_{100-Z}M_{Z}
(20<X<45, 0.5<Y<5, 0.5<Z<5)
(M is an element selected from Ag, Cr, Si, Ga, Al, In, B and N)

Further, by adding Bi₂Te₃ to the Ge—Sb—Te-based recording layer material containing GeTe and Sb₂Te₃ in a proper mixture ratio, the nucleation speed can be improved and thereby excellent reading/writing characteristics can be obtained also in the CAV recording from the inner radius to the outer radius of the information recording medium. The addition of Bi₂Te₃ increases the crystal growth speed very much and highly enhances the difference of refractive index between amorphous and crystal, thereby the playback signal amplitude can be improved. Specifically, the effects can be obtained by setting the content of Bi to 1 to 9%. Especially, recording layer materials within the following compositional formula (atomic percent) are excellent.
(Ge_{X-Y}Sb_{40-0.8X+2Y}Te_{60-0.2X-Y})_{100-Z}(Bi₂Te₃)_{Z}
(20<X<45, −2<Y<2, 2.5<Z<25)

Incidentally, even if other impurities are contained in the recording layer, the effects of the present invention are not lost if the relationship among the four elements is kept within the above compositional formula and the content of the impurities is 1 atomic % or less.

The optimum thickness of the recording layer in the optical sense is 5 to 15 nm in the medium structure according to the present invention. Especially, setting the recording layer thickness between 7 nm and 11 nm is advantageous to the reduction of the playback signal deterioration due to recording layer dissolution after frequent rewriting and to the optical optimization of the modulation factor.

<Second Interface Layer>

As discussed before in detail, it is desirable that the second interface layer contains material Bi, Sn, Pb, etc. having the recording layer crystallization promotion effect. Especially, telluride or oxide of Bi, Sn or Pb; a mixture of germanium nitride and telluride or oxide of Bi, Sn or Pb; and a mixture of transition metal oxide or transition metal nitride and telluride or oxide of Bi, Sn or Pb are suitable. Transition metal easily changes its valence, therefore, even when elements such as Bi, Sn, Pb and Te became liberated, the transition metal changes its valence and combines with the elements Bi, Sn, Pb and Te and thereby forms thermally stable compounds. Especially, Cr, Mo and W can be employed as excellent transition metals since they have high melting points and easily change their valences and thereby form thermally stable compounds with the elements. For improving the recording layer crystallization speed and especially improving the recording layer nucleation speed, it is desirable that the content of the telluride or oxide of Bi, Sn or Pb in the second interface layer should be set as high as possible unless it is impossible in the thermal or chemical sense.

The second interface layer can achieve its effect if its thickness is 0.5 nm or more. However, when the thickness becomes below 1 nm, there are cases where the second protective layer material dissolves into the recording layer through the second interface layer and thereby the playback signal quality after frequent rewriting is deteriorated. Therefore, it is desirable that the thickness should be set to 1 nm or more. On the other hand, too much thickness over 3 nm might cause optical ill effects caused by deterioration of reflectivity, drop in signal amplitude, etc., therefore, desirable thickness of the second interface layer is 1 nm to 3 nm.

<Second Protective Layer>

As the material of the second protective layer, material exhibiting no light absorption is desirable, and is especially desirable if it includes oxide, carbide, nitride, sulfide and/or selenide of metal. Further, thermal conductivity of the material should be 2 W/mk or less. Above all, ZnS—SiO₂-based compounds have low thermal conductivity and are the most suitable for the second protective layer. Further, SnO₂, SnO₂ doped with sulfide ZnS, CdS, SnS, GeS, PbS, etc., and SnO₂ doped with transition metal oxide SnO₂, Cr₂O₃, Mo₃O₄, etc. exhibit especially excellent characteristics as the second protective layer thanks to their low thermal conductivity and thermal stability higher than that of the ZnS—SiO₂-based material, since dissolution into the recording layer can be avoided even if the thickness of the second interface layer became 1 nm or less. From the viewpoint of the effective use of optical interference between the recording layer and the absorptivity control layer, the optimum thickness of the second protective layer is 25 nm to 45 nm in the case where the laser beam wavelength is about 650 nm.

<Absorptivity Control Layer>

As the material of the absorptivity control layer, materials whose complex refractive index n, k satisfy 1.4<n<4.5 and −3.5<k<−0.5, respectively, which is desirable. It is especially desirable if 2<n<4 and −3.0<k<−0.5 are satisfied. Materials having thermal stability are suitable for the absorptivity control layer since it absorbs light. Preferably, material with a melting point of 1000° C. or more is required. While high cross-erasing reduction effect was obtained by adding sulfide to the protective layer, in the absorptivity control layer, the content of sulfide ZnS etc. should be set at least lower than that in the protective layer since there can be ill effects of the sulfide such as drop in melting point, thermal conductivity, absorptivity, etc. As the composition of the absorptivity control layer, a mixture of metal and metal oxide, metal sulfide, metal nitride or metal carbide is desirable. A mixture of Cr and Cr₂O₃ exhibited an excellent effect on the improvement of overwrite characteristics. Especially by setting the Cr content to 60 to 95 atomic %, material with thermal conductivity and optical constants suitable for the present invention can be obtained. Specifically, as the aforementioned metal, Al, Cu, Ag, Au, Pt, Pd, Co, Ti, Cr, Ni, Mg, Si, V, Ca, Fe, Zn, Zr, Nb, Mo, Rh, Sn, Sb, Te, Ta, W, Ir, Pb and their mixture are preferable. As the metal oxide, metal sulfide, metal nitride or metal carbide, SiO₂, SiO, TiO₂, Al₂O₃, Y₂O₃, CeO, La₂O₃, In₂O₃, GeO, GeO₂, PbO, SnO, SnO₂, Bi₂O₃, TeO₂, MO₂, WO₂, WO₃, Sc₂O₃, Ta₂O₅ and ZrO₂ are desirable, for example. Other than the above materials, oxides such as Si—O—N-based material, Si—Al—O—N-based material, Cr—O-based material such as Cr₂O₃ etc. and Co—O-based material such as CO₂O₃, CoO, etc.; nitrides such as TaN, AlN, Si—N-based material Si₃N₄ etc., Al—Si—N-based material such as AlSiN₂ etc. and Ge—N-based material; sulfides such as ZnS, Sb₂S₃, CdS, In₂S₃, Ga₂S₃, GeS, SnS₂, PbS and Bi₂S₃; selenides such as SnSe₃, Sb₂S₃, CdSe, ZnSe, In₂Se₃, Ga₂Se₃, GeSe, GeSe₂, SnSe, PbSe and Bi₂Se₃; and fluorides such as CeF₃, MgF₂ and CaF₂ can also be employed for the absorptivity control layer. Materials having composition similar to the above materials can also be used.

Desirable thickness of the absorptivity control layer is 10 nm to 100 nm. Especially when the thickness is 20 nm to 50 nm, overwrite characteristics are improved excellently. The cross-erasing reduction effect becomes remarkable when the sum of the thicknesses of the protective layer and the absorptivity control layer is larger than the groove depth. The absorptivity control layer has the property of absorbing light as mentioned before, therefore, the absorptivity control layer also heats up similarly to the recording layer due to the light absorption. It is important that the absorptivity of the absorptivity control layer, when the recording layer is amorphous, becomes larger than that when the recording layer is crystalline. Such optical design has the effect of letting the absorptivity Aa of the recording layer when it is amorphous be smaller than that Ab when it is crystalline. The overwrite characteristics can widely be improved thanks to the effect. For attaining the above characteristics, the absorptivity of the absorptivity control layer have to be increased up to 30 to 40%. The amount of heat generation in the absorptivity control layer changes depending on whether the recording layer is crystalline or amorphous, thereby heat flow from the recording layer to the thermal diffusion layer changes depending on the state of the recording layer. By the phenomenon, the increase of jitter due to overwriting can be reduced.

The above effect is caused by the heat blocking effect of the absorptivity control layer, blocking the heat flow from the recording layer to the thermal diffusion layer, which increases when the temperature of the absorptivity control layer increases. In order to make the most of the effect, the sum of the thicknesses of the protective layer and the absorptivity control layer should be set larger than the level difference between the land and groove (groove depth on the substrate, approximately 1/7 to ⅕ of the laser beam wavelength). If the sum of the thicknesses of the protective layer and the absorptivity control layer is smaller than the land-groove level difference, heat generated in the recording layer during recording is easily transferred by the thermal diffusion layer, thereby record marks on adjacent tracks tend to be erased.

<Thermal Diffusion Layer>

Metal or alloy having high reflectivity and high thermal conductivity is suitable as the material of the thermal diffusion layer, and its is preferable that the total content of Al, Cu, Ag, Au, Pt and Pd in the thermal diffusion layer is set to 90 atomic % or more. Materials having high melting points and high hardness (Cr, Mo, W, etc.) and alloys of such materials are also favorable for the prevention of the recording layer material deterioration due to dissolution. Especially when the Al content of the thermal diffusion layer is 95 atomic % or more, an information recording medium with low price, high CNR, high recording density, high resistance to frequent rewriting, extremely high cross-erasing reduction effect, and high corrosion resistance can be realized. Elements such as Co, Ti, Cr, Ni, Mg, Si, V, Ca, Fe, Zn, Zr, Nb, Mo, Rh, Sn, Sb, Te, Ta, W, Ir, Pb, B and C are excellent as additional elements for Al from the viewpoint of corrosion resistance, in which Co, Cr, Ti, Ni and Fe especially have much effect on the improvement of corrosion resistance. Desirable thickness of the thermal diffusion layer is 30 nm to 100 nm. If the thickness of the thermal diffusion layer is decreased below 30 nm, diffusion of heat generated in the recording layer becomes difficult, thereby the recording layer deterioration or the cross-erasing might occur after rewriting of about 100,000 times. Further, light transmission due to the thinness might make the usage as the thermal diffusion layer difficult and thereby the playback signal amplitude might be deteriorated. It is advantageous from the viewpoint of production if the metallic elements contained in the thermal diffusion layer are the same as those contained in the absorptivity control layer, since the two layers can be deposited by use of the same target. In this case, the absorptivity control layer having a proper refractive index is formed by carrying out sputtering using mixed gas such as Ar—O₂ gas or Ar—N₂ gas and thereby letting the metallic elements react with oxygen or nitrogen during the sputtering. The thermal diffusion layer made of metal having high thermal conductivity is formed by means of sputtering using Ar gas.

In accordance with the present invention, the following examples are also described as features of the present invention.

(1) An information recording method for recording information on an information recording medium by use of phase change reaction of a recording layer which is caused by laser beam irradiation, wherein:
the information recording medium comprises: a substrate; the recording layer which can be rewritten a plurality of times; a first interface layer which is provided to a laser-beam-incident side of the recording layer so as to be in contact with the recording layer; and a second interface layer which is provided to the opposite side of the recording layer so as to be in contact with the recording layer, and
both the first interface layer and the second interface layer contain one or more elements selected from Bi, Sn and Pb, and the total content of the elements in the first interface layer is lower than that in the second interface layer.

(2) A method for manufacturing a medium by use of a sputtering apparatus having a plurality of chambers, comprising:
a first step for forming a first interface layer containing nitrogen and one or more elements selected from Bi, Sn and Pb on a substrate by means of reactive sputtering with nitrogen gas using a first chamber;
a second step for forming a recording layer on the first interface layer using a second chamber; and
a third step for forming a second interface layer containing one or more elements selected from Bi, Sn and Pb so that the total content of the elements will be higher than that in the first interface layer using a third chamber.

(3) A method for manufacturing a medium as described in (2), wherein nitrogen gas is fed to the third chamber at a flow rate lower than that in the first chamber and thereby the second interface layer is formed so as to further contain nitrogen.

(4) An information recording medium comprising:
a substrate;
a recording layer on which information is recorded by use of phase change reaction which is caused by laser beam irradiation and which can be rewritten a plurality of times, containing Ge, Sb and Te within a compositional formula: Ge_{X-Y}Sb_{40-0.8X+2Y}Te_{60-0.2X-Y}(20<X<45, 0.5<Y<5); and
an interface layer which is provided so as to be in contact with the recording layer, containing one or more elements selected from Bi, Sn and Pb.

(5) An information recording medium comprising:
a substrate; and
a recording layer on which information is recorded by use of phase change reaction which is caused by laser beam irradiation and which can be rewritten a plurality of times, containing at least Ge, Sb, Te and Bi with the Bi content of 1 to 9%.

(6) An information recording medium as described in (5), wherein the composition of the recording layer is within a compositional formula: (Ge_{X-Y}Sb_{40-0.8X+2Y}Te_{60-0.2X-Y})_{100-Z}(Bi₂Te₃)_{z} (20<X<45, −2<Y<2, 5<Z<25).

As set forth hereinabove, in the information recording medium, the method for recording information and the method for manufacturing the information recording medium in accordance with the present invention, the first interface layer and the second interface layer are formed so as to contain elements Bi, Sn, Pb, etc. having the recording layer crystallization promotion effect, and the content of the elements Bi, Sn, Pb, etc. in the first interface layer is set lower than that in the second interface layer in order to suppress the dissolution of the low-melting-temperature elements into the recording layer. By such composition of the interface layers, the playback signal deterioration after frequent rewriting which is cause by the dissolution of interface layer material into the recording layer can be reduced while improving the nucleation speed of the recording layer.

As the recording layer material, a material comprised of the well-known Ge—Sb—Te-based recording layer material containing GeTe and Sb₂Te₃ in a proper mixture ratio and an excessive amount of Sb added thereto can be employed. By such composition of the recording layer, the problems which are caused by the recrystallization at the inner radius of the information recording medium can be resolved even when the CAV recording is employed.

By adding Bi₂Te₃ to the Ge—Sb—Te-based recording layer material containing GeTe and Sb₂Te₃ in a proper mixture ratio, the nucleation speed can be improved and thereby excellent reading/writing characteristics can be obtained also in the CAV recording from the inner radius to the outer radius of the information recording medium. Since the recording layer doped with Bi₂Te₃ has a large refractive index difference between amorphous and crystal, the playback signal amplitude can be improved.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

1. An information recording medium comprising:
a substrate;
a recording layer on which information is recorded by use of phase change reaction which is caused by laser beam irradiation and which can be rewritten a plurality of times; and
a first interface layer which is provided so as to be in contact with the recording layer, containing transition metal oxygen and one or more elements selected from Bi, Sn and Pb.

2. An information recording medium as claimed in claim 1, wherein the transition metal contained in the first interface layer including Cr, Mo or W.

3. An information recording medium as claimed in claim 1, wherein said first interface layer is provided to a laser-beam-incident side of the recording layer.

4. An information recording medium as claimed in claim 1, further comprising:
a second interface layer containing one or more elements selected from Bi. Sn and Pb is provided to the opposite side of the recording layer so as to be in contact with the recording layer, wherein
a total content of the elements Bi, Sn and Pb in the first interface layer is lower than that in the second interface layer.

5. An information recording medium as claimed in claim 1, wherein said recording layer satisfying a composition formula: (Ge_{X-Y}Sb_{40-0.8X+2Y}Te_{60-0.2X-Y})_{100-Z}(Bi₂Te₃)_{Z}, 20<X<45, 2<Y<2, 5<Z<25.
